(19) United States
(12) Patent Application Publication
(10) Pub. No.: US 2010/0304822 A1
(43) Pub. Date: Dec. 2, 2010

(54) GAMING MACHINE DISPLAYING PAYOUT RATE AND CONTROL METHOD THEREOF

(75) Inventor: Kazuo OKADA, Koto-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: UNIVERSAL ENTERTAINMENT CORPORATION, Koto-ku (JP); Aruze Gaming America, Inc., Las Vegas, NV (US)

(21) Appl. No.: 12/781,387

(22) Filed: May 17, 2010

(30) Foreign Application Priority Data
Jun. 1, 2009 (JP) 2009-132473

(51) Int. Cl. A63F 9/24; A63F 13/00

(52) U.S. Cl. 463/16; 463/30; 463/37; 463/25; 463/43

(57) ABSTRACT

A gaming machine includes a selection device for accepting a selection operation of one of playing states for a basic game, and a controller. The controller is operable to (a) set a playing state for the basic game according to the selection operation accepted by the selection device, (b) start the basic game with the playing state, (c) display payout rates for the basic game in areas on a display [the areas are allocated to the playing states one by one], respectively, and (d) set, during the basic game, a background color in one of the areas corresponding to the playing state set in (a) to a different color from another color of backgrounds in others of the areas. According to the gaming machine, a player can be informed of the payout rate along with the playing state.

### CROSS-REFERENCE TO RELATED APPLICATION

This application is based upon and claims priority of Japanese Patent Application No. 2009-132473, filed on Jun. 1, 2009, the entire contents of which are incorporated herein by reference.

### BACKGROUND OF THE INVENTION

1. Field of the Invention

The present invention relates to a gaming machine in which a payout rate for a basic game is preset according to a playing state of the basic game and a control method thereof.

2. Discussion of the Background

In the specification of the U.S. Pat. No. 5,178,390 (Patent Document 1), disclosed is a slot machine in which symbols are arranged and then rearranged on its display in a basic game by spinning and then stopping its reels. In the slot machine, in a basic game, when a winning combination is established along an activated payline, a payout is provided according to the established winning combination. The number of activated paylines varies along with the number of BETs on a basic game. In addition, in the slot machine, when the accumulated number of BETs on basic games reaches a preset value, a bonus for rescuing a player is established and a payout with the preset number of payouts is provided. The accumulation of the number of BETs starts when a BET for rescue is firstly placed that is different from a BET on a basic game. Further, the accumulation of the number of BETs on basic games is reset when a payout more than a preset value is provided due to an establishment of a winning combination along an activated payline. Furthermore, the accumulation of the number of BETs on basic games is also reset when a payout for rescuing a player is provided due to an establishment of a bonus.

In a conventional gaming machine that relates to the technical field of the present invention and is typified by the above-mentioned slot machine, a payout rate(s) for a basic game is preliminarily determined along with the performance of the gaming machine. The payout rate for a basic game is a rate of the total number of the payouts to the total number of BETs on a basic game. The payout rate(s) is preliminarily determined along with a playing state(s). For example, in a case of the above-mentioned slot machine, a playing state varies according to the number of BETs on a basic game and a presence/absence of a bet for rescuing.

### SUMMARY OF THE INVENTION

However, in the conventional gaming machine that relates to the technical field of the present invention and is typified by the above-mentioned slot machine, a player can't play with previously recognizing the payout rate for a basic game along with the playing state of the basic game.

An object of the present invention is to provide a gaming machine that can inform a player of a payout rate for a basic game along with a playing state of the basic game, and to provide a control method thereof.

A first aspect of the present invention provides a gaming machine that includes a selection device for accepting a selection operation of one of plural playing states for a basic game, an input device for accepting an input to start the basic game, a display for displaying images, and a controller. The controller is operable to (a) set a playing state for the basic game according to the selection operation accepted by the selection device, (b) start the basic game with the playing state set in (a) when the input is accepted by the input device, (c) display plural payout rates for the basic game in plural areas on the display [the plural areas are allocated to the plural playing states one by one], respectively, and (d) set, during execution of the basic game, a background color in one of the plural areas that is allocated to the playing state set in (a) to a different color from another color of backgrounds in others of the plural areas.

According to the first aspect of the present invention, the basic game is started with the playing state set according to the selection operation accepted by the selection device, when the input is accepted by the input device. In addition, according to the first aspect of the present invention, the plural payout rates for the basic game are displayed in the plural areas on the display, respectively. Here, the plural areas are allocated to the plural playing states one by one. Further, according to the first aspect of the present invention, during execution of the basic game, the background color in the one of the plural areas allocated to the playing state of the basic game is set to the different color from the other color of backgrounds in the others of the plural areas.

Therefore, a player can easily recognize the payout rate by displaying the plural payout rates for the basic game in the plural areas on the display, respectively. In addition, the player can also easily recognize the payout rate applied to the current basic game (the current playing state) by setting the background color in the one of the plural areas allocated to the playing state set according to the selection operation through the selection device to the different color from the other color of backgrounds in the others of the plural areas.

A second aspect of the present invention provides a gaming machine that includes a bet switch for placing a bet on a basic game, a mode switch for setting an insurance mode, an input device for accepting an input to start the basic game, a display for displaying images, and a controller. The controller is operable to (a) set one of plural playing states as a playing state for the basic game according to the bet placed by the bet switch and the insurance mode set by the mode switch, (b) start the basic game with the playing state set in (a) when the input is accepted by the input device, (c) display plural payout rates for the basic game in plural areas on the display [the plural areas are allocated to the plural playing states one by one], respectively, and (d) set, during execution of the basic game, a background color in one of the plural areas that is allocated to the playing state set in (a) to a different color from another color of backgrounds in others of the plural areas.

According to the second aspect of the present invention, the basic game is started with the playing state that is set, when the input is accepted by the input device. The playing state for the basic game is set according to the bet placed by the bet switch and the insurance mode set by the mode switch. In addition, according to the second aspect of the present invention, the plural payout rates for the basic game are displayed in the plural areas on the display, respectively. Here, the plural areas are allocated to the plural playing states one by one. Further, according to the second aspect of the present invention, during execution of the basic game, the background color in the one of the plural areas allocated to the playing state of the basic game is set to the different color from the other color of backgrounds in the others of the plural areas.

Therefore, a player can easily recognize the payout rate by displaying the plural payout rates for the basic game in the plural areas on the display, respectively. In addition, the player can also easily recognize the payout rate applied to the current basic game (the current playing state) by setting the background color in the one of the plural areas allocated to the playing state set according to the bet placed by the bet switch and the insurance mode set by the mode switch to the different color from the other color of backgrounds in the others of the plural areas.

A third aspect of the present invention provides a gaming machine that includes a bet switch for placing a bet on a basic game, a mode switch for setting an insurance mode, an input device for accepting an input to start the basic game, a display for displaying images for the basic game and images of plural areas that are allocated to plural playing states one by one, an image data memory for storing basic game image data including the images for the basic game and area image data including the images of the plural areas, a pallet memory for sorting color data of background colors in the plural areas; a frame memory for storing video image data of the basic game and the plural areas [the video image data are generated based on the basic game image data, the area image data and the color data], and a controller. The controller is operable to (a) set one of the plural playing states as a playing state for the basic game according to the bet placed by the bet switch and the insurance mode set by the mode switch, (b) start the basic game with the playing state set in (a) when the input is accepted by the input device, (c) assign, based on the color data stored in the pallet memory, a different color from another color of backgrounds in others of the plural areas to a background color in one of the plural areas that is allocated to the playing state set in (a), (d) display plural payout rates for the basic game in the plural areas on the display [the plural payout rates are allocated to plural playing states one by one], respectively, and (e) display, during execution of the basic game, the background color in the one of the plural areas that is allocated to the playing state set in (a) with the different color.

According to the third aspect of the present invention, the basic game is started with the playing state that is set, when the input is accepted by the input device. The playing state for the basic game is set according to the bet placed by the bet switch and the insurance mode set by the mode switch. In addition, according to the third aspect of the present invention, the background color in the one of the plural areas that is allocated to the playing state is, based on the color data stored in the pallet memory, assigned to the different color from the other color of backgrounds in the others of the plural areas. Further, according to the third aspect of the present invention, the plural payout rates for the basic game are displayed in the plural areas on the display, respectively. Furthermore, according to the third aspect of the present invention, during execution of the basic game, the background color in the one of the plural areas that is allocated to the playing state of the basic game is displayed with the different color on the display while displaying the basic game on the display.

Therefore, a player can easily recognize the payout rate by displaying the plural payout rates for the basic game in the plural areas on the display, respectively. In addition, the player can also easily recognize the payout rate applied to the current basic game (the current playing state) by setting the background color in the one of the plural areas allocated to the playing state set according to the bet placed by the bet switch and the insurance mode set by the mode switch to the different color from the other color of backgrounds in the others of the plural areas.

A fourth aspect of the present invention provides a control method of a gaming machine including a controller, a selection device, an input device and a display. The method includes (a) with the controller, setting a playing state for the basic game according to a selection operation accepted by the selection device, (b) with the controller, starting the basic game with the playing state set in (a) when an input is accepted by the input device, (c) with the controller, displaying plural payout rates for the basic game in plural areas on the display, respectively, the plural areas being allocated to the plural playing states one by one, and (d) with the controller, setting, during execution of the basic game, a background color in one of the plural areas that is allocated to the playing state set in (a) to a different color from another color of backgrounds in others of the plural areas.

According to the fourth aspect of the present invention, the controller starts the basic game with the playing state set according to the selection operation accepted by the selection device, when the input is accepted by the input device. In addition, according to the fourth aspect of the present invention, the controller displays the plural payout rates for the basic game in the plural areas on the display, respectively. Here, the plural areas are allocated to the plural playing states one by one. Further, according to the fourth aspect of the present invention, during execution of the basic game, the controller sets the background color in the one of the plural areas allocated to the playing state of the basic game to the different color from the other color of backgrounds in the others of the plural areas.

Therefore, a player can easily recognize the payout rate by displaying the plural payout rates for the basic game in the plural areas on the display, respectively. In addition, the player can also easily recognize the payout rate applied to the current basic game (the current playing state) by setting the background color in the one of the plural areas allocated to the playing state set according to the selection operation through the selection device to the different color from the other color of backgrounds in the others of the plural areas.

According to the gaming machine and the control method thereof, it can be easily done to inform a player of payout rates for a basic game relating to playing states. In addition, it can be also done to inform the player of a current payout rate applied to a current basic game (a current playing state).

### BRIEF DESCRIPTIONS OF THE DRAWINGS

FIG. 1 is a view illustrating a display example indicating a playing state and a payout rate relating thereto in a gaming machine according to a first embodiment of the present invention;

FIG. 2 is a view illustrating a function flow of the gaming machine according to a first embodiment of the present invention;

FIG. 3 is a view illustrating a game system including the gaming machine according to the first embodiment of the present invention;

FIG. 4 is a view illustrating an overall configuration of the gaming machine according to the first embodiment of the present invention;

FIG. 5 is a view illustrating arrangements of symbols drawn on peripheral surfaces of reels of the gaming machine according to the first embodiment of the present invention;

FIG. 6 is a block diagram illustrating an internal configuration of the gaming machine according to the first embodiment of the present invention;

FIG. 7 is a view illustrating a symbol combination table of the gaming machine according to the first embodiment of the present invention;

FIG. 8 is a view illustrating a flowchart of main control processing for the gaming machine according to the first embodiment of the present invention;

FIG. 9 is a flowchart illustrating coin-insertion/start-check processing for the gaming machine according to the first embodiment of the present invention;

FIG. 10 is a view illustrating a flowchart of jackpot-related processing for the gaming machine according to the first embodiment of the present invention;

FIG. 11 is a view illustrating a flowchart of insurance-related processing for the gaming machine according to the first embodiment of the present invention;

FIG. 12 is a view illustrating a flowchart of symbol lottery processing for the gaming machine according to the first embodiment of the present invention;

FIG. 13 is a view illustrating a flowchart of symbol display control processing for the gaming machine according to the first embodiment of the present invention;

FIG. 14 is a view illustrating a flowchart of number-of-payouts determination processing for the gaming machine according to the first embodiment of the present invention;

FIG. 15 is a view illustrating a flowchart of insurance-check processing for the gaming machine according to the first embodiment of the present invention;

FIG. 16 is a view illustrating a flowchart of bonus-game execution processing for the gaming machine according to the first embodiment of the present invention;

FIG. 17 is a view illustrating a flowchart of payout rate update processing for the gaming machine according to the first embodiment of the present invention;

FIG. 18 is a view illustrating a flowchart of the insurance selection processing for the gaming machine according to the first embodiment of the present invention.

FIG. 19 is a view illustrating a payout rate display portion in the gaming machine according to a modified example of the first embodiment of the present invention;

FIG. 20 is a view illustrating a payout rate display portion in the gaming machine according to another modified example of the first embodiment of the present invention;

FIG. 21 is a view illustrating a flowchart of main control processing for the gaming machine according to a second embodiment of the present invention;

FIG. 22 is a flowchart illustrating coin-insertion/start-check processing for the gaming machine according to the second embodiment of the present invention;

FIG. 23 is a view illustrating a flowchart of payout rate update processing for the gaming machine according to the second embodiment of the present invention;

FIG. 24 is a view illustrating an overall configuration of the gaming machine according to a third embodiment of the present invention;

FIG. 25 is a block diagram illustrating an internal configuration of the gaming machine according to the third embodiment of the present invention;

FIG. 26 is a flowchart illustrating coin-insertion/start-check processing for the gaming machine according to the third embodiment of the present invention;

FIG. 27 is a view illustrating a flowchart of payout rate update processing for the gaming machine according to the third embodiment of the present invention;

FIG. 28 is a view illustrating a payout rate display portion in the gaming machine according to a modified example of the third embodiment of the present invention;

FIG. 29 is a view illustrating a payout rate display portion in the gaming machine according to another modified example of the third embodiment of the present invention;

FIG. 30 is a view illustrating a flowchart of insurance-related processing for the gaming machine according to a fourth embodiment of the present invention;

FIG. 31 is a view illustrating a flowchart of insurance-check processing for the gaming machine according to the fourth embodiment of the present invention; and

FIG. 32 is a view illustrating a flowchart of insurance-management processing for the gaming machine according to a fourth embodiment of the present invention.

### DESCRIPTION OF THE EMBODIMENTS

Hereinafter, embodiments of the present invention will be described with reference to the drawings. First, a first embodiment of the present invention will be described hereinafter.

### First Embodiment

A gaming machine according to the first embodiment includes a 1-BET button, a maximum BET button, an insurance set switch, a spin button that accepts an input for starting a basic game, and an upper image display panel. In the gaming machine, (a) a playing state for the basic game is set according to the operations of the 1-BET button, the maximum BET button and the insurance set switch, (b) the basic game is started with the playing state set in (a) when the spin button is operated, (c) plural payout rates for the basic game are displayed in plural areas on the upper image display panel [the plural areas are allocated to the plural playing states one by one], respectively, and (d) during execution of the basic game, a background color in one of the plural areas that is allocated to the playing state set in (a) is set to a different color from another color of backgrounds in others of the plural areas.

In the case of the conventional gaming machine, it is needed for a player to presume the payout rate for the basic game relating to the playing state of the basic game with referring to displayed contents of a help screen in the gaming machine, contents of a book or a web page showing strategy guides for the gaming machine, or the like. However, according to the present embodiment, the plural payout rates for the basic game are displayed in the plural areas on the upper image display panel, respectively, so that a player can easily recognize the payout rate. In addition, the background color in the one of the plural areas allocated to the playing state set according to the player's operation is set to the different color from the other color of backgrounds in the others of the plural areas, so that the player can also easily recognize the payout rate applied to the current basic game (the current playing state).

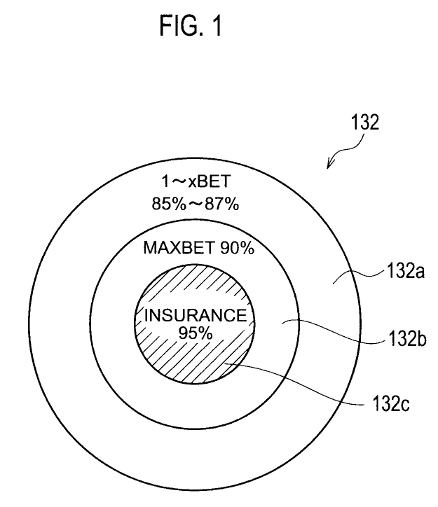

Hereinafter, general configurations of the present embodiment will be described with reference to FIG. 1. In the gaming machine according to the present embodiment, the playing states for the basic game and the payout rates relating thereto are displayed on a payout rate display portion 132, as shown in FIG. 1.

The payout rate display portion 132 includes three areas 132a to 132c segmented by three concentric circles. The areas 132a to 132c are assigned to three states of the playing states of the gaming machine (“1- to x-BET”, “maximum BET”, and “insurance-effective”), respectively. The playing state of “insurance-effective” is a state in which a bet for insurance is placed in addition to a maximum BET and will be explained later in detail. The areas 132a to 132c display the payout rates relating to the playing states, respectively. In addition, an area relating to a current playing state among the areas 132a to 132c is displayed with a red background color, and other areas are displayed with a blue background color.

Therefore, in the gaming machine according to the present embodiment, a player can easily recognize the payout rates relating to the playing states and the current payout rate applied to the current basic game by seeing the values and colors within the areas 132a to 132c.

### [Explanation of Function Flow Diagram]

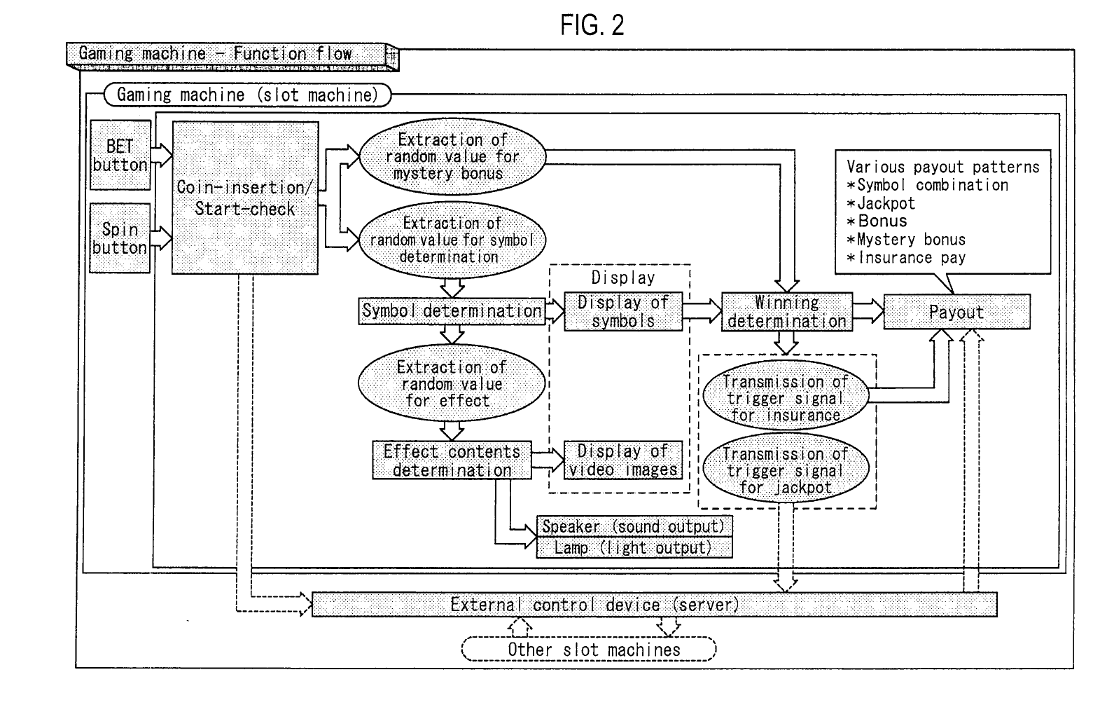

With reference to FIG. 2, basic functions of the gaming machine according to the first embodiment of the present invention are described. FIG. 2 is a view illustrating a function flow of the gaming machine according to the first embodiment of the present invention.

### <Coin-Insertion/Start-Check>

First, the gaming machine checks whether or not a BET button has been pressed by the player, and subsequently checks whether or not a spin button 31 has been pressed by the player.

### <Symbol Determination>

Next, when the spin button 31 has been pressed by the player, the gaming machine extracts random values for symbol determination, and determines symbols to be displayed at the time of stopping scrolling of symbol arrays for the player, for a plurality of respective video reels displayed to a display.

### <Symbol Display>

Next, the gaming machine starts scrolling of the symbol array of each of the video reels and then stops scrolling so that the determined symbols are displayed for the player.

### <Winning Determination>

When scrolling of the symbol array of each video reel has been stopped, the gaming machine determines whether or not a combination of symbols displayed for the player is a combination related to winning.

### <Payout>

When the combination of symbols displayed for the player is a combination related to winning, the gaming machine offers benefits according to the combination to the player.

For example, when a combination of symbols related to a payout of coins has been displayed, the gaming machine pays out coins of the number corresponding to the combination of symbols to the player.

Further, when a combination of symbols related to a bonus game trigger has been displayed, the gaming machine starts the bonus game. Note that, in the present embodiment, a game will be executed as a bonus game without consumption of coins, in which the above-mentioned lotteries for determining symbols to be displayed will be done in a predetermined number of times.

When a combination of symbols related to a jackpot trigger is displayed, the gaming machine pays out coins in an amount of jackpot to the player. The jackpot refers to a function which accumulates parts of coins used by players at the respective gaming machines as the amount of jackpot and which, when the jackpot trigger has been established in any of the gaming machines, pays out coins of the accumulated amount of jackpot to that gaming machine.

In each game, the gaming machine calculates the amount (amount for accumulation) to be accumulated to the amount of jackpot and transmits to an external control device. The external control device accumulates to the amount of jackpot the amounts for accumulation transmitted from the respective gaming machines.

Further, in addition to the aforementioned benefits, the gaming machine is provided with benefits such as a mystery bonus and insurance.

The mystery bonus is a bonus in which a predetermined amount of coins are paid out for winning of a lottery that is intended for the mystery bonus. When the spin button 31 has been pressed, the gaming machine extracts a random value for mystery bonus and determines whether or not to establish a mystery bonus trigger by lottery.

The insurance is a function provided for a purpose of relieving the player from a situation in which a bonus game has not been played for long periods of time. In the present embodiment, the player can arbitrarily select whether or not to make the insurance effective. Making insurance effective requires a predetermined insurance-purchase amount to be paid in exchange.

In the case where the insurance has been made effective, the gaming machine starts counting the number of games. The gaming machine conducts a payout of coins of the amount that is set for the insurance for an establishment of the insurance trigger, when the number of counted games has reached a previously determined number of times without a large amount of payout relating to a bonus game or the like being conducted.

### <Determination of Effects>

The gaming machine produces effects by displaying images to the display, outputting the light from lamps, and outputting sounds from speakers. The gaming machine extracts a random value for effect and determines contents of the effects based on the symbols and the like determined by lottery.

### [Overall Game System]

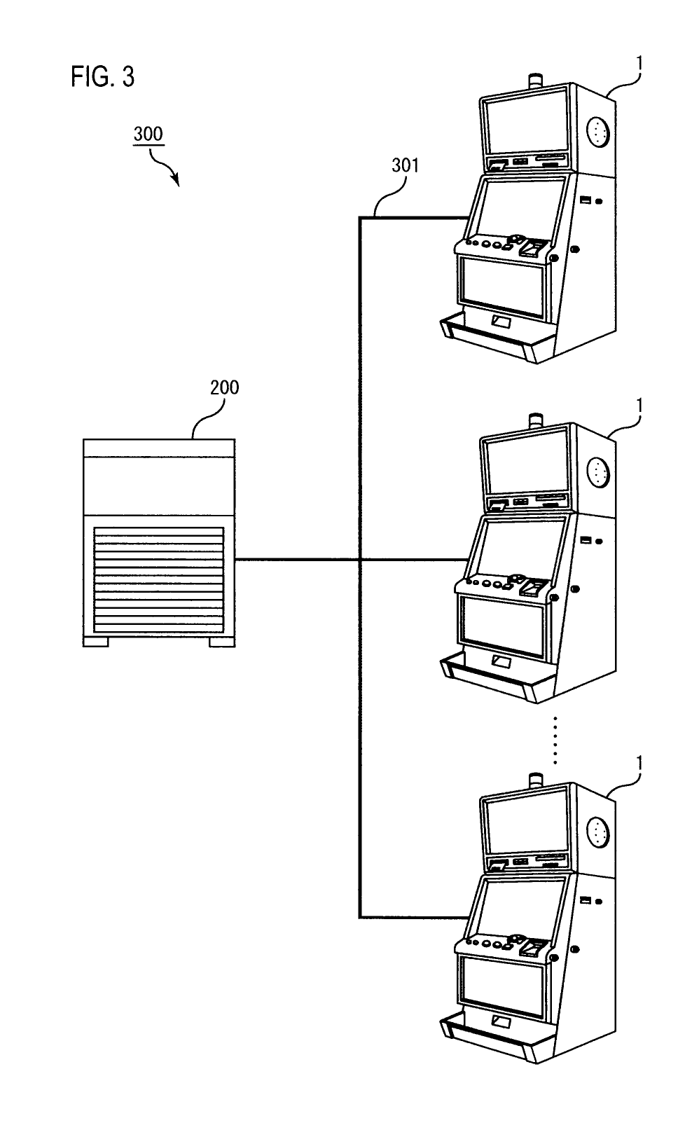

The basic functions of the gaming machine have been described above. Next, with reference to FIG. 3, a game system including the gaming machine is described. FIG. 3 is a view illustrating the game system including the gaming machine according to the first embodiment of the present invention.

A game system 300 includes the plurality of gaming machines 1, and an external control device 200 that is connected to each of the gaming machines 1 through a communication line 301.

The external control device 200 is for controlling the plurality of gaming machines 1. In the present embodiment, the external control device 200 is a so-called hall server which is installed in a game facility having the plurality of gaming machines 1. Each of the gaming machines 1 is provided with a unique identification number, and the external control device 200 identifies transmission sources of data transmitted from the respective gaming machines 1 by using the identification numbers. Also in the case where the external control device 200 transmits data to a gaming machine 1, the identification numbers are used for specifying the transmission destination.

It is to be noted that the game system 300 may be constructed within a single game facility where various games can be conducted, such as a casino, or may be constructed among a plurality of game facilities. Further, when the game system 300 is constructed in a single game facility, the game system 300 may be constructed in each floor or section of the game facility. The communication line 301 may be a wired or wireless line, and can adopt a dedicated line, an exchange line or the like.

### [Overall Configuration of Gaming Machine]

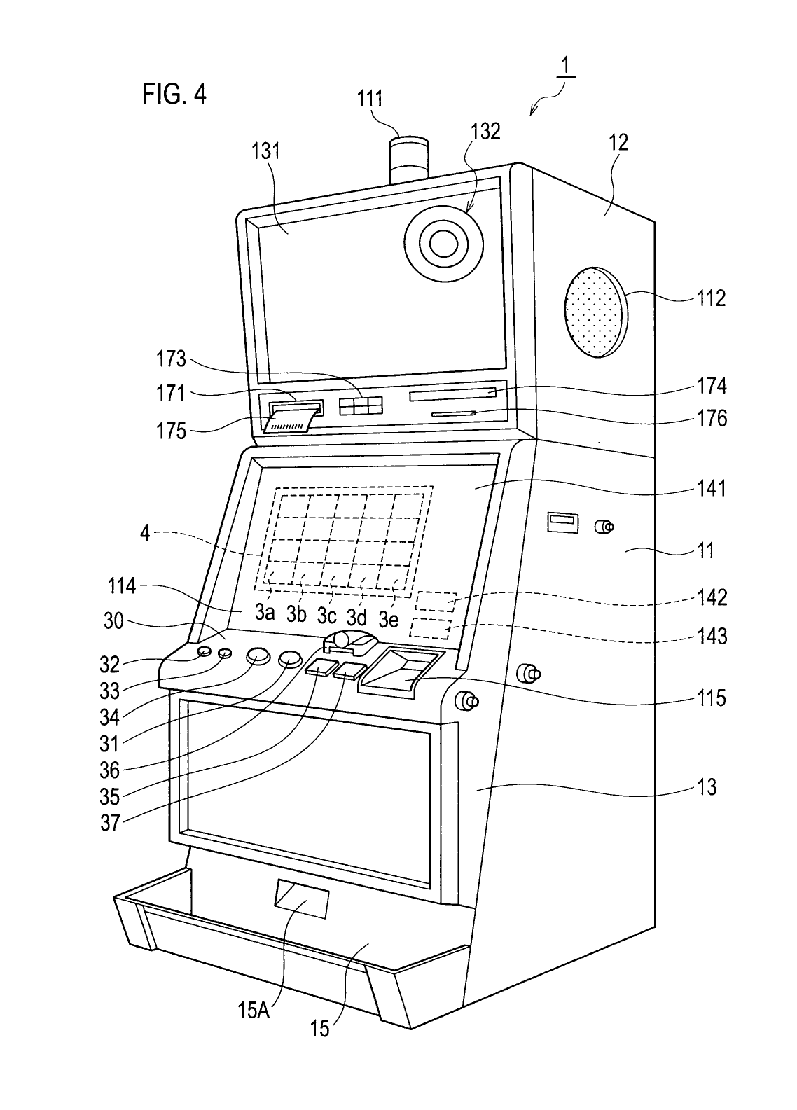

The game system according to the present embodiment has been described above. Next, with reference to FIG. 4, an overall configuration of the gaming machine 1 is described. FIG. 4 is a view illustrating the overall configuration of the gaming machine according to the first embodiment of the present invention.

A coin, a bill, or electrically valuable information corresponding to these is used as a game medium in the gaming machine 1. Further, in the present embodiment, a later-described ticket with a barcode is also used. It is to be noted that the game medium is not limited to these, and for example a medal, a token, electric money or the like can be adopted.

The gaming machine 1 includes a cabinet 11, a top box 12 installed on the upper side of the cabinet 11, and a main door 13 provided at the front face of the cabinet 11.

A lower image display panel 141 is provided at the center of the main door 13. The lower image display panel 141 includes a liquid crystal panel, and forms the display. The lower image display panel 141 has a symbol display region 4. To the symbol display region 4, five video reels 3 (3a, 3b, 3c, 3d, 3e) are displayed.

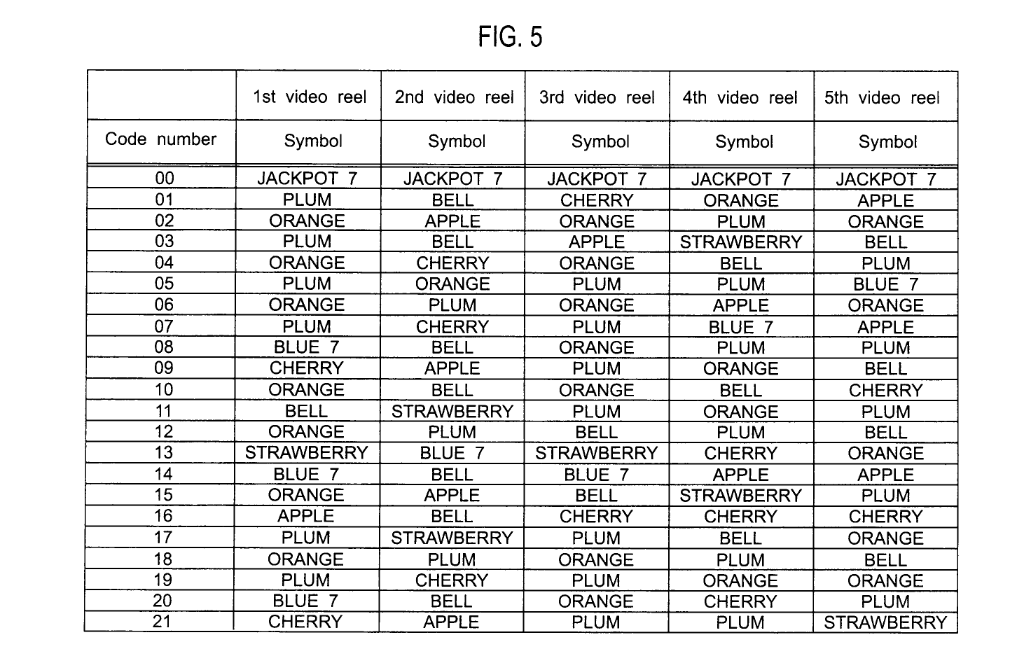

In the present embodiment, a video reel depicts through videos the rotational and stop motions of a mechanical reel having a plurality of symbols drawn on the peripheral surface thereof. To each of the video reels 3, a symbol array comprised of a previously determined plurality (22 in the present embodiment) of symbols is assigned (see FIG. 5 which is described later).

In the symbol display region 4, the symbol arrays assigned to the respective video reels 3 are separately scrolled, and are stopped after predetermined time has elapsed. As a result, a part (four consecutive symbols in the present embodiment) of each of the symbol arrays is displayed for the player.

The symbol display region 4 has four regions, namely an upper region, an upper central region, a lower central region, and a lower region, for each video reel 3, and a single symbol is to be displayed to each region. That is, 20 (=5 columns×4 symbols) symbols are to be displayed in the symbol display region 4.

In the present embodiment, a line formed by selecting one of the aforementioned four regions for each of the video reels 3 and connecting the respective regions is referred to as a winning line.

It is to be noted that any desired shape of the winning line can be adopted, and examples of the shape of the winning line may include a straight line formed by connecting the upper central regions for the respective video reels 3, a V-shaped line, and a bent line. Also, any desired number of lines can be adopted, and the number can be for example 30 lines.

In addition, the lower image display panel 141 includes a credit-number display area 142 and a number-of-payouts display area 143. In the number-of-credits display area 142, displayed is the number of coins that are possessed by a payer and pooled in the gaming machine 1 (the number of credits). In addition, in the number-of-payouts display area 143, displayed is the number of coins that is paid out to a player when winning is established (the number of payouts).

The lower image display panel 141 has a built-in touchscreen 114. The player can input various commands by touching the lower image display panel 141.

On the lower side of the lower image display panel 141, there are arranged various buttons set in a control panel 30, and various devices to be operated by the player.

A spin button 31 is used when starting scrolling of the symbol arrays of the respective video reels 3. A change button 32 is used when requesting a game facility staff member to exchange money. A CASHOUT button 33 is used when paying out the coins retained inside the gaming machine 1 to a coin tray 15.

A 1-BET button 34 and a maximum BET button 35 are used for determining the number of coins (hereinafter also referred to as “the number of BETs”) to be used in the game from the coins retained inside the gaming machine 1. The 1-BET button 34 is used when determining one coin at a time for the aforementioned number of BETs. The maximum BET button 35 is used when setting the aforementioned number of BETs to a defined upper limit number.

A coin accepting slot 36 is provided to accept coins. A bill validator 115 is provided to accept bills. The bill validator 115 validates a bill, and accepts a valid bill into the cabinet 11. It is to be noted that the bill validator 115 may be configured so as to be capable of reading a later-described ticket 175 with a barcode.

An insurance set button 37 is used for making “insurance” effective. The “insurance” is a function for compensating a player's loss. For example, the player's loss may be a situation wherein no bonus game trigger is won during the preset number of successive basic games (e.g. 1000 games). The compensation for the loss is made by providing the preset amount of a payout.

The “insurance” is made effective when the insurance set button 37 is operated. When the “insurance” is made effective, some of medals bet on a basic game are collected as a preset premium for the “insurance”. In other words, in addition to a bet on the basic game, another bet on the insurance is needed in order to make the “insurance” effective. For example, in the gaming machine (slot machine) 1 according to the present embodiment, one medal is collected as a bet on the insurance from ten medals bet on a basic game when activating the “insurance”. For example, 2000 medals will be provided when the insurance trigger is established.

An upper image display panel 131 is provided at the front face of the top box 12. The upper image display panel 131 includes a liquid crystal panel, and forms the display. The upper image display panel 131 displays images related to effects and images showing introduction of the game contents and explanation of the game rules. Further, the payout rate display portion 132 shown in FIG. 1 is provided on the upper image display panel 131.

The outermost area 132a of the payout rate display portion 132 corresponds to the playing state with the number of BETs of 1- to x-BET (fewer-than maximum BET) for the basic game. The payout rate corresponding to the playing state “fewer-than maximum BET” is displayed in the area 132a (85% to 87%).

The middle area 132b of the payout rate display portion 132 corresponds to the playing state with the number of BETs of the maximum BET for the basic game. The payout rate corresponding to the playing state “maximum BET” is displayed in the area 132b (90%).

The center area 132c of the payout rate display portion 132 corresponds to the playing state with the number of BETs of the maximum BET for the basic game and also with the insurance-effective. The payout rate corresponding to the playing state “insurance-effective” (i.e. the maximum BET is placed and the insurance is also effective) is displayed in the area 132c (95%).

The payout rates for the playing state displayed in the areas 132a to 132c are preliminarily determined. The payout rate corresponding to the current playing state is applied to the basic game executed in the gaming machine 1.

The current playing state of the gaming machine 1 is determined according to the average number of BETs placed during the preset number of latest basic games. The playing state of the gaming machine 1 is periodically updated. Its updating cycle may be every execution of the basic game or the preset number of executions of the basic games. In the present embodiment, the updating cycle is set to the preset number of executions of the basic games.

When the playing state of the gaming machine 1 is updated, also updated is the payout rate applied to the basic games executed in the gaming machine 1. During a period in which the payout rate is never updated and also the number of the executed basic games does not reach to the preset number of games set as the updating cycle, it can be adopted to automatically apply one of the payout rates corresponding to the three playing states (“fewer-than maximum BET”, “maximum BET” or “insurance-effective”). In the present embodiment, the payout rate corresponding to the playing state “fewer-than maximum BET” is applied.

Note that FIG. 1 shows a state in which the current playing state is the insurance-effective. In this case, the area 132c that corresponds to the current playing state is displayed with its background color made red (preset color). The other areas 132a and 132b are displayed with their background colors made blue that is different from the background color of the area 132c corresponding to the current playing state. At a default state just after the gaming machine 1 activated, the area 132a that corresponds to the playing state with the fewer-than maximum BET is displayed with its background color made red. The other areas 132b and 132c are displayed with their background colors made blue. This default state is continued until the number of the executed basic games reaches to the preset number of games set as the updating cycle.

In addition, the top box 12 is provided with a speaker 112 and a lamp 111, as shown in FIG. 4. The gaming machine 1 produces effects by displaying images, outputting sounds, and outputting the light.

A ticket printer 171, a card slot 176, a data display 174, and a keypad 173 are provided on the lower side of the upper image display panel 131.

The ticket printer 171 prints on a ticket a barcode representing encoded data of the number of credits, date, the identification number of the gaming machine 1, and the like, and outputs the ticket as the ticket 175 with a barcode. The player can make a gaming machine read the ticket 175 with a barcode so as to play a game thereon, and can also exchange the ticket 175 with a barcode with a bill or the like at a predetermined place (e.g. a cashier in a casino) in the game facility.

The card slot 176 is for inserting a card in which predetermined data are stored. For example, the card stores data for identifying the player, and data about the history of games played by the player.

When the card is inserted into the card slot 176, a later-described card reader 172 reads data from the card or writes data into the card. It is to be noted that the card may store data corresponding to a coin, a bill or a credit.

The data display 174 includes a fluorescent display, LEDs and the like, and displays the data read by the card reader 172 or the data inputted by the player via the keypad 173, for example. The keypad 173 is for inputting a command and data related to ticket issuance or the like.

### [Symbol Arrays of Video Reels]

The overall configuration of the gaming machine 1 has been described above. Next, with reference to FIG. 5, a configuration of the symbol arrays included in the video reels 3 of the gaming machine 1 is described. FIG. 5 is a view illustrating the arrangements of symbols drawn on the peripheral surfaces of the reels of the gaming machine according to the first embodiment of the present invention.

A first video reel 3a, a second video reel 3b, a third video reel 3c, a fourth video reel 3d, and a fifth video reel 3e each is assigned with a symbol array consisting of 22 symbols that correspond to respective code numbers from “00” to “21”.

Types of the symbols provided are “JACKPOT 7”, “BLUE 7”, “BELL”, “CHERRY”, “STRAWBERRY”, “PLUM”, “ORANGE”, and “APPLE”.

### [Configuration of Circuit Included in Gaming Machine]

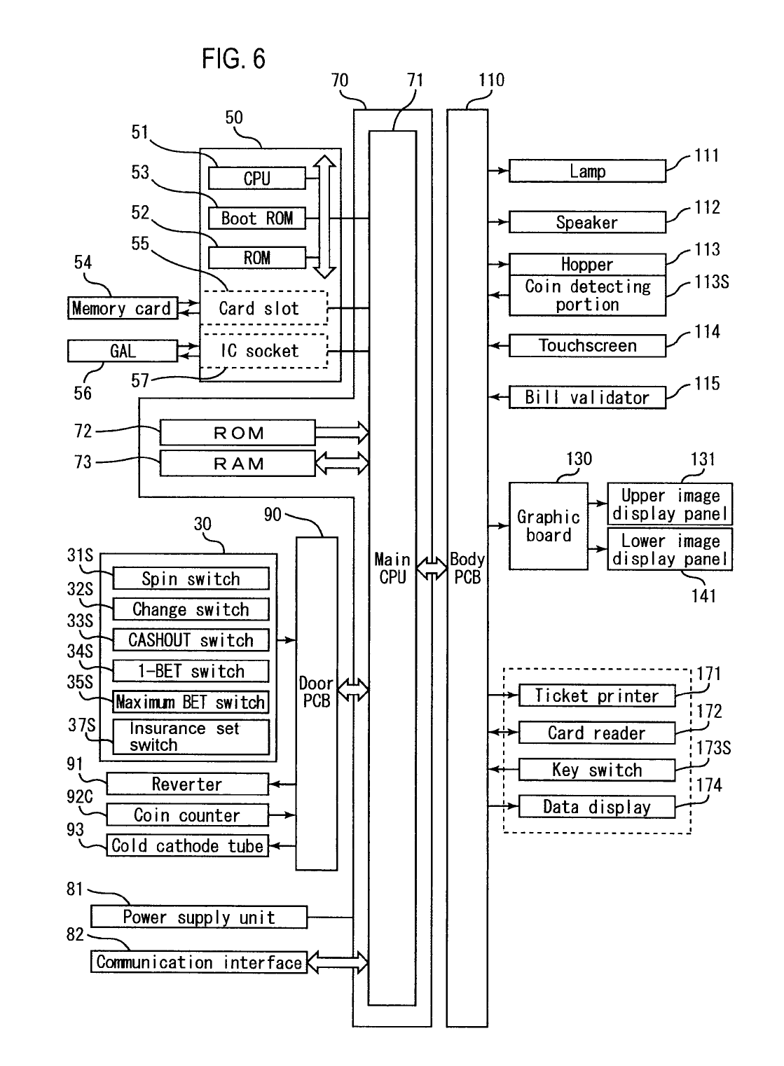

The configuration of the symbol arrays included in the video reels 3 of the gaming machine 1 has been described above. Next, with reference to FIG. 6, a configuration of a circuit included in the gaming machine 1 is described. FIG. 6 is a block diagram illustrating an internal configuration of the gaming machine according to the first embodiment of the present invention.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

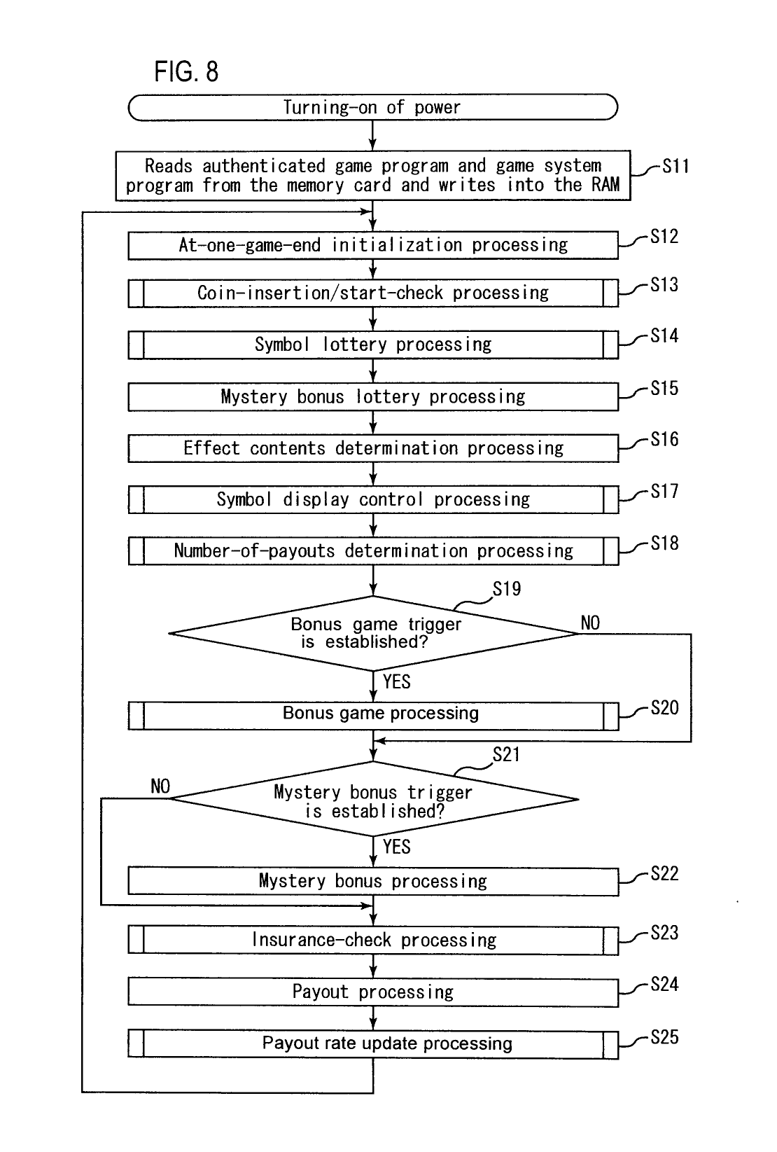

The memory card 54 includes a non-volatile memory, and stores a game program and a game system program. The game program includes a program related to game progression, a lottery program, and a program for producing effects by images and sounds (e.g. see FIGS. 8 to 18 which are described later). Further, the aforementioned game program includes data (see FIG. 5) specifying the configuration of the symbol array assigned to each video reel 3.

The lottery program is a program for determining to-be stopped symbol of each video reel 3 by lottery. The to-be stopped symbol is data for determining four symbols to be displayed to the symbol display region 4 out of the 22 symbols forming each symbol array. The gaming machine 1 of the present embodiment determines as the to-be stopped symbol the symbol to be displayed in a predetermined region (e.g. the upper region) out of the four regions provided for each of the video reels 3 of the symbol display region 4.

The aforementioned lottery program includes symbol determination data. The symbol determination data is data that specifies random values so that each of the 22 symbols (code numbers from “00” to “21”) forming the symbol array is determined at an equal probability (i.e. 1/22), for each video reel 3.

The probabilities of the respective 22 symbols being determined are basically equal. However, the numbers of the respective types of symbols included in the 22 symbols vary, and thus the probabilities of the respective types of symbols being determined vary (i.e. different weights on the probabilities are generated). For example, with reference to FIG. 5, the symbol array of the first video reel 3a includes one symbol of “JACKPOT 7”, and includes seven symbols of “orange”. Hence, the former is determined at the probability of “ 1/22”, whereas the latter is determined at the probability of “ 7/22”.

It is to be noted that, although the data specifies that the equal numbers of symbols be provided to form the symbol arrays of the respective video reels 3 in the present embodiment, different numbers of symbols may form the respective video reels 3. For example, the symbol array of the first video reel 3a may consist of 22 symbols whereas the symbol array of the second video reel 3b may consist of 30 symbols. Such a configuration increases the degree of freedom in setting the probabilities of the respective types of symbols being determined for each video reel 3.

Further, the card slot 55 is configured so that the memory card 54 can be inserted thereinto and removed therefrom, and is connected to a motherboard 70 by an IDE bus.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents of the game to be played on the gaming machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the pre-authentication program, and the like.

The authentication program is a program (tamper check program) for authenticating the game program and the game system program. The pre-authentication program is a program for authenticating the aforementioned authentication program. The authentication program and the pre-authentication program are written along a procedure (authentication procedure) for proving that the program to be the subject has not been tampered.

The motherboard 70 is provided with a main CPU 71, a ROM 72, a RAM 73, and a communication interface 82.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted; further, through the gaming board 50, processing of loading the game program and the game system program stored in the memory card 54 is started.

The RAM 73 stores data and programs which are used in operation of the main CPU 71. For example, when the processing of loading the aforementioned game program, game system program or authentication program is conducted, the RAM 73 can store the program. The RAM 73 is provided with working areas used for operations in execution of these programs. Examples of the areas include: an area that stores the number of games, the number of BETs, the number of payouts, the number of credits and the like; and an area that stores symbols (code numbers) determined by lottery.

The communication interface 82 is for communicating with the external control device 200 such as a server, through the communication line 301. Further, the motherboard 70 is connected with a later-described door PCB (Printed Circuit Board) 90 and a body PCB 110 by respective USBs. The motherboard 70 is also connected with a power supply unit 81.

When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the body PCB 110 are connected with input devices such as a switch and a sensor, and peripheral devices the operations of which are controlled by the main CPU 71.

The door PCB 90 is connected with a control panel 30, a reverter 91, a coin counter 92C and a cold cathode tube 93.

The control panel 30 is provided with a spin switch 31S, a change switch 32S, a CASHOUT switch 33S, a 1-BET switch 34S, a maximum BET switch 35S and an insurance set switch 37S which correspond to the aforementioned respective buttons. Each of the switches outputs a signal to the main CPU 71 upon detection of press of the button corresponding thereto by the player.

The coin counter 92C validates a coin inserted into the coin accepting slot 36 based on its material, shape and the like, and outputs a signal to the main CPU 71 upon detection of a valid coin. Invalid coins are discharged from a coin payout exit 15A.

The reverter 91 operates based on a control signal outputted from the main CPU 71, and distributes valid coins validated by the coin counter 92C into a hopper 113 or a cash box (not illustrated). That is, coins are distributed into the hopper 113 when the hopper 113 is not filled with coins, while coins are distributed into the cash box when the hopper 113 is filled with coins.

The cold cathode tube 93 functions as a backlight installed on the rear face sides of the upper image display panel 131 and the lower image display panel 141, and lights up based on a control signal outputted from the main CPU 71.

The body PCB 110 is connected with the lamp 111, the speaker 112, the hopper 113, a coin detecting portion 113S, the touchscreen 114, the bill validator 115, a graphic board 130, the ticket printer 171, the card reader 172, a key switch 173S and the data display 174.

The lamp 111 lights up based on a control signal outputted from the main CPU 71. The speaker 112 outputs sounds such as BGM, based on a control signal outputted from the main CPU 71.

The hopper 113 operates based on a control signal outputted from the main CPU 71, and pays out coins of the specified number of payouts from the coin payout exit 15A to the coin tray 15. The coin detecting portion 1135 outputs a signal to the main CPU 71 upon detection of coins paid out by the hopper 113.

The touchscreen 114 detects a place on the lower image display panel 141 touched by the player's finger or the like, and outputs to the main CPU 71 a signal corresponding to the detected place. Upon acceptance of a valid bill, the bill validator 115 outputs to the main CPU 71 a signal corresponding to the face amount of the bill.

The graphic board 130 controls display of images conducted by the respective upper image display panel 131 and lower image display panel 141, based on a control signal outputted from the main CPU 71. The symbol display region 4 of the lower image display panel 141 displays the five video reels 3 by which the scrolling and stop motions of the symbol arrays included in the respective video reels 3 are displayed. The graphic board 130 is provided with a VDP generating image data, a video RAM temporarily storing the image data generated by the VDP, and the like. The number-of-credits display area 142 of the lower image display panel 141 displays the number of credits stored in the RAM 73. The number-of-payouts display area 143 of the lower image display panel 141 displays the number of payouts of coins.

The graphic board 130 is provided with the VDP (Video Display Processor) generating image data based on a control signal outputted from the main CPU 71, the video RAM temporarily storing the image data generated by the VDP, and the like. It is to be noted that the image data and color pallet data used in generation of image data by the VDP is included in the game program that has been read from the memory card 54 and stored into the RAM 73.

Therefore, the RAM 73 of the mother board 70 functions as a pallet memory. The pallet memory stores color data relating to background colors of images of the basic game, color data relating to the background colors of images of the areas 132a to 132c of the payout rate display portion 132, and so on. In addition, the RAM of the graphic board 130 functions as an image data memory. The image data memory stores the image data of the basic game, image data of the areas 132a to 132c of the payout rate display portion 132, and so on. Further, the RAM of the graphic board 130 functions as a frame memory. The frame memory stores video image data of the basic game that is generated by the VDP using the image data and color data of the basic game, video image data of the areas 132a to 132c generated by the VDP using the image data and color data of the areas 132a to 132c, and so on.

Based on a control signal outputted from the main CPU 71, the ticket printer 171 prints on a ticket a barcode representing encoded data of the number of credits stored in the RAM 73, date, the identification number of the gaming machine 1, and the like, and then outputs the ticket as the ticket 175 with a barcode.

The card reader 172 reads data stored in a card inserted into the card slot 176 and transmits the data to the main CPU 71, or writes data into the card based on a control signal outputted from the main CPU 71.

The key switch 173S is provided in the keypad 173, and outputs a predetermined signal to the main CPU 71 when the keypad 173 has been operated by the player.

The data display 174 displays data read by the card reader 172 and data inputted by the player through the keypad 173, based on a control signal outputted from the main CPU 71.

### [Configuration of Symbol Combination Table]

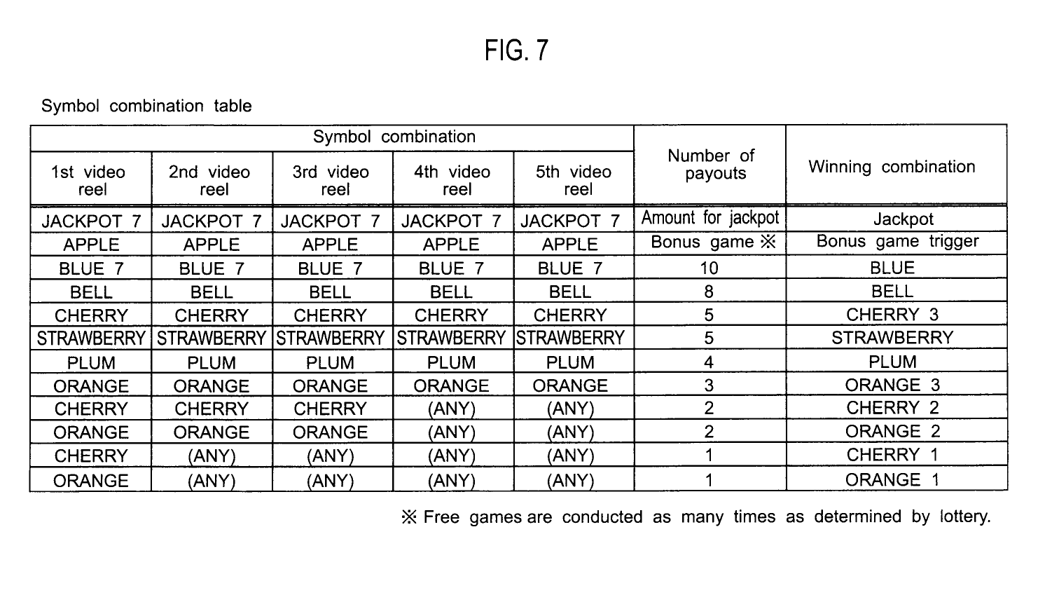

The circuit configuration of the gaming machine 1 has been described above. Next, with reference to FIG. 7, a symbol combination table is described. FIG. 7 is a view illustrating a symbol combination table of the gaming machine according to the first embodiment of the present invention.

The symbol combination table specifies combinations of drawn symbols relating to winning, and the number of payouts. On the gaming machine 1, the scrolling of symbol arrays of the respective video reels 3 is stopped, and winning is established when the combination of symbols displayed along the winning line matches one of the combinations of symbols specified by the symbol combination table. According to the winning combination, a benefit such as payout of coins or start of a bonus game is offered to the player. It is to be noted that winning is not established (i.e. the game is lost) when the combination of symbols displayed along the winning line does not match any of the combinations of symbols specified by the symbol combination table.

Basically, winning is established when all symbols displayed along the winning line by the respective video reels 3 are of one type out of “JACKPOT 7”, “APPLE”, “BLUE 7”, “BELL”, “CHERRY”, “STRAWBERRY”, “PLUM” and “ORANGE”. However, with respect to the respective types of symbols of “CHERRY” and “ORANGE”, winning is also established when one or three symbols of either type are displayed along the winning line by the video reels 3.

For example, when all the symbols displayed along the winning line by all the video reels 3 are “BLUE 7”, the winning combination is “BLUE”, and “10” is determined as the number of payouts. Based on the determined number of payouts, payout of coins is conducted. The payout of coins is conducted by actually discharging coins from the coin payout exit 15A or adding the determined number of payouts to the number of credits, or issuing a ticket with a barcode.

“JACKPOT 7” is a symbol related to the jackpot trigger. When all the symbols displayed along the winning line by all the video reels 3 are “JACKPOT 7”, the winning combination is “jackpot”, and the amount of jackpot is determined as the number of payouts.

“APPLE” is a symbol related to the bonus-game trigger. When all the symbols displayed along the winning line by all the video reels 3 are “APPLE”, the winning combination is “bonus game”, and bonus games start from the next game.

### [Contents of Program]

The symbol combination table has been described above. Next, with reference to FIGS. 8 to 18, the program to be executed by the gaming machine 1 according to the first embodiment of the present invention is described.

### <Main Control Processing>

First, with reference to FIG. 8, main control processing is described. FIG. 8 is a view illustrating a flowchart of the main control processing for the gaming machine according to the first embodiment of the present invention.

First, when the power is supplied to the gaming machine 1, the main CPU 71 reads the authenticated game program and game system program from the memory card 54 through the gaming board 50, and writes the programs into the RAM 73 (step S11). In addition, the main CPU 71 sets a presentation of the payout rate display portion 132 as a default state. In other words, background color of the area 132a of the payout rate display portion 132 is set to red and background colors of the other areas 132b and 132c are set to blue.

Next, the main CPU 71 conducts at-one-game-end initialization processing (step S12). For example, data that becomes unnecessary after each game in the working areas of the RAM 73, such as the number of BETs and the symbols determined by lottery, is cleared.

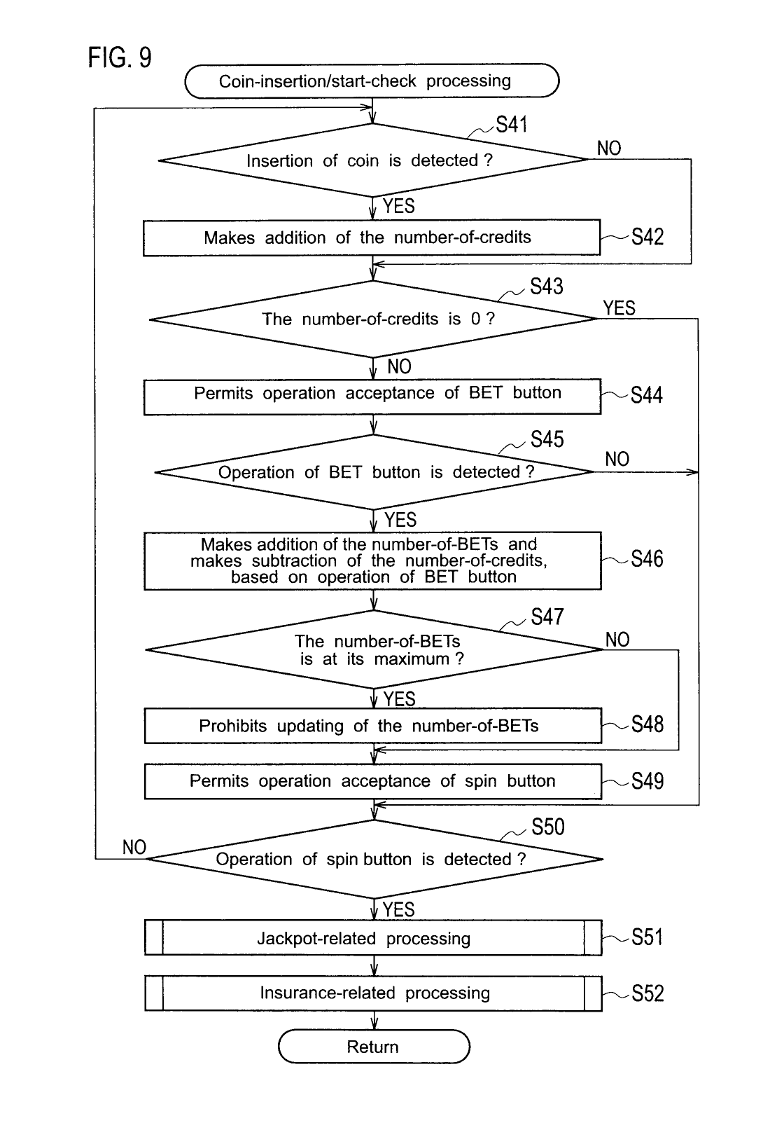

The main CPU 71 conducts coin-insertion/start-check processing which is described later with reference to FIG. 9 (step S13). In the processing, input from the BET switch and the spin switch is checked.

The main CPU 71 then conducts symbol lottery processing which is described later with reference to FIG. 12 (step S14). In the processing, to-be stopped symbols are determined based on the random values for symbol determination.

Next, the main CPU 71 conducts mystery bonus lottery processing (step S15). In the processing, lottery determining whether or not to establish a mystery bonus trigger is held. For example, the main CPU 71 extracts a random value for mystery bonus from the numbers in a range of “0 to 99”, and establishes the mystery bonus trigger when the extracted random value is “0”.

The main CPU 71 conducts effect contents determination processing (step S16). The main CPU 71 extracts a random value for effect, and determines any of the effect contents from the preset plurality of effect contents by lottery.

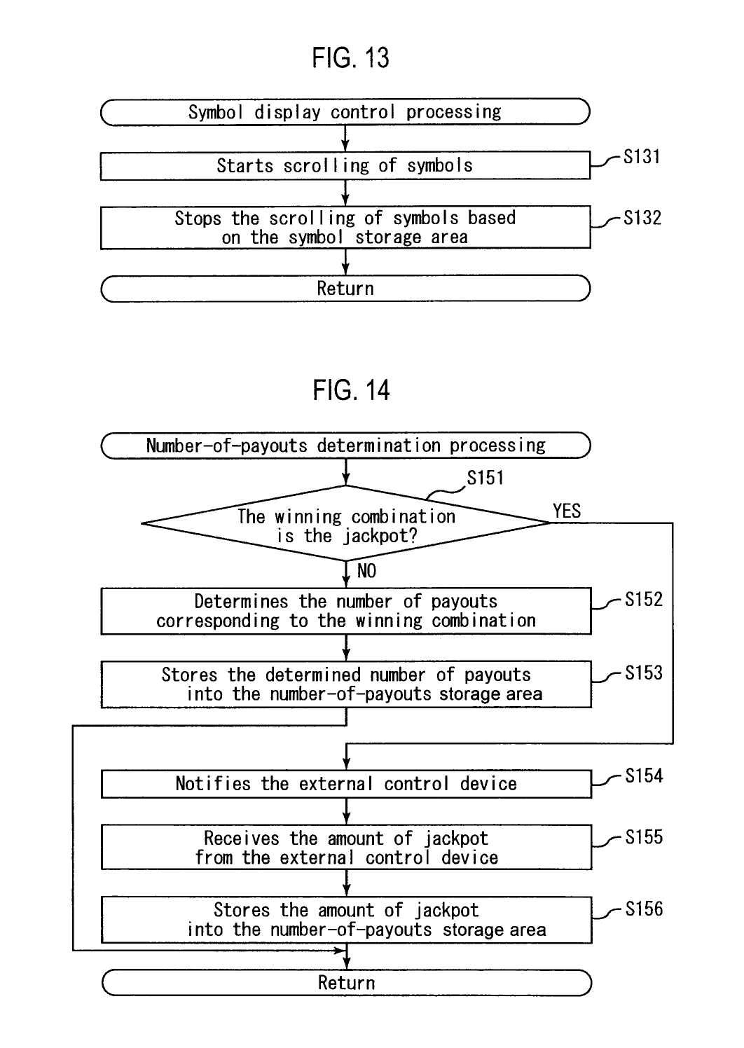

The main CPU 71 then conducts symbol display control processing which is described later with reference to FIG. 13 (step S17). The symbol display control processing is processing for displaying a basic game on the lower image display panel 141. The video image data used for displaying the basic game are generated by the VDP of the graphic board 130 by using the image data and the color data in the RAM 73 and stored in the frame memory of the RAM of the graphic board 130. In the processing, scrolling of the symbol array of each video reel 3 is started, and the to-be stopped symbol determined in the symbol lottery processing of step S14 is stopped at a predetermined position (e.g. the upper region in the symbol display region 4). That is, four symbols including the to-be stopped symbol are displayed in the symbol display region 4. For example, when the to-be stopped symbol is the symbol associated with the code number of “10” and it is to be displayed to the upper region, the symbols associated with the respective code numbers of “11”, “12” and “13” are to be displayed to the respective upper central region, lower central region and lower region in the symbol display region 4.

Next, the main CPU 71 conducts number-of-payouts determination processing which is described later with reference to FIG. 14 (step S18). In the processing, the number of payouts is determined based on the combination of symbols displayed along the winning line, and is stored into a number-of-payouts storage area provided in the RAM 73.

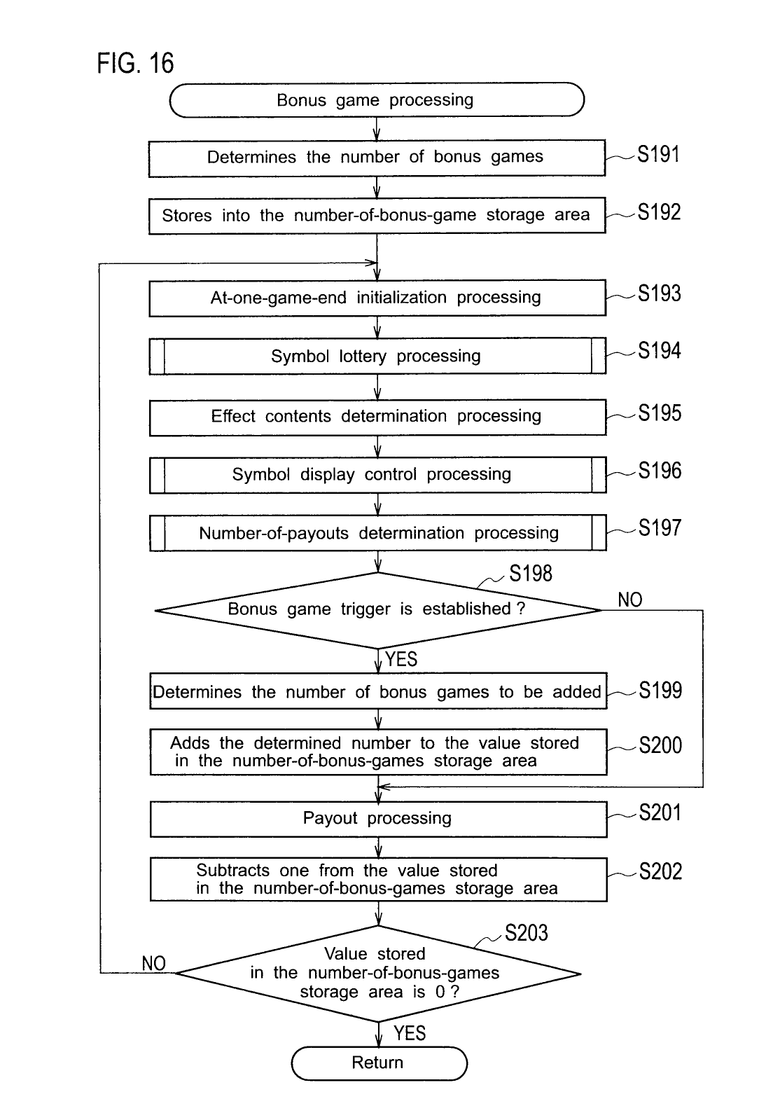

The main CPU 71 then determines whether or not the bonus game trigger has been established (step S19). When the main CPU 71 determines that the bonus game trigger has been established, the main CPU 71 conducts bonus game processing which is described later with reference to FIG. 16 (step S20).

After the processing of step S20 or when determining in step S19 that the bonus game trigger has not been established, the main CPU 71 determines whether or not the mystery bonus trigger is established (step S21). When determining that the mystery bonus trigger has been established, the main CPU 71 conducts the mystery bonus processing (step S22). In the processing, the number of payouts (e.g. 300) being set for the mystery bonus is stored into the number-of-payouts storage area provided in the RAM 73.

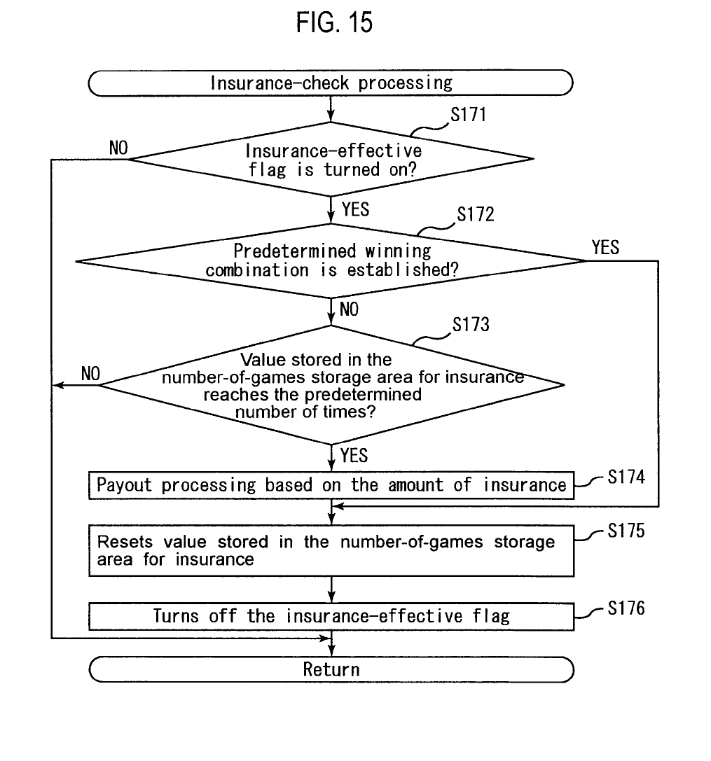

After the processing of step S22 or when determining in step S21 that the mystery bonus trigger has not been established, the main CPU 71 conducts insurance-check processing which is described later with reference to FIG. 15 (step S23). In the processing, whether or not to conduct payout by the insurance is checked.

The main CPU 71 conducts payout processing (step S24). The main CPU 71 adds the value stored in the number-of-payouts storage area to a value stored in a number-of-credits storage area provided in the RAM 73. It is to be noted that operations of the hopper 113 may be controlled based on input from the CASHOUT switch 33S, and coins of the number corresponding to the value stored in the number-of-payouts storage area may be discharged from the coin payout exit 15A. Further, operations of the ticket printer 171 may be controlled and a ticket with a barcode may be issued on which a value stored in the number-of-payouts storage area is recorded.

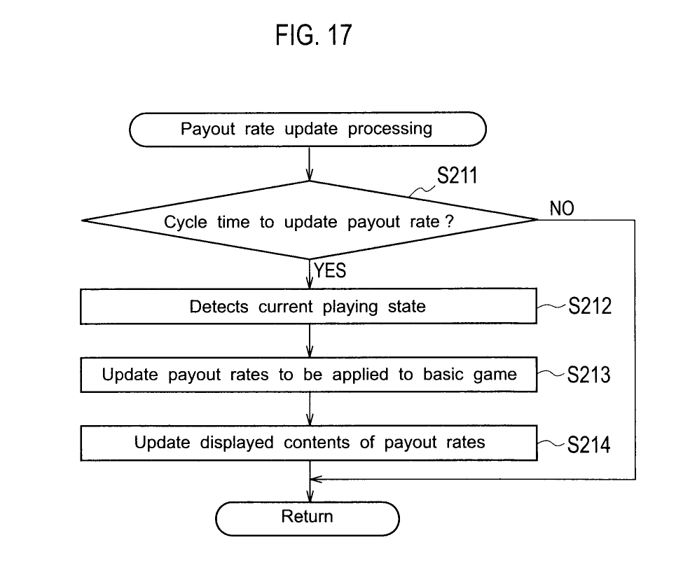

The main CPU 71 conducts payout rate update processing that will be described later with reference to FIG. 17 (step S25). In the processing, conducted is an update of a payout rate to be applied to the following basic games. After the processing has been conducted, the processing is shifted to step S12.

### <Coin-Insertion/Start-Check Processing>

Next, with reference to FIG. 9, coin-insertion/start-check processing in step S13 shown in FIG. 8 is described. FIG. 9 is a view illustrating a flowchart of the coin-insertion/start-check processing for the gaming machine according to the first embodiment of the present invention.

First, the main CPU 71 determines whether or not insertion of a coin has been detected by the coin counter 92C (step S41). When determining that the insertion of a coin has been detected by the coin counter 92C, the main CPU 71 makes an addition to the value stored in the number-of-credits storage area (step S42). It is to be noted that, in addition to the insertion of a coin, the main CPU 71 may determine whether or not insertion of a bill has been detected by the bill validator 115, and when determining that the insertion of a bill has been detected, the main CPU 71 may add a value according to the bill to the value stored in the number-of-credits storage area.

After step S42 or when determining in step S41 that the insertion of a coin has not been detected, the main CPU 71 determines whether or not the value stored in the number-of-credits storage area is zero (step S43). When the main CPU 71 determines that the value stored in the number-of-credits storage area is not zero, the main CPU 71 permits operation acceptance of the BET buttons (the 1-BET button 34, the maximum BET button 35) (step S44).

Next, the main CPU 71 determines whether or not operation of any of the BET buttons has been detected (step S45). When the main CPU 71 detects the player's pressing of any of the BET buttons through the BET switches (the 1-BET switch 34S, the maximum BET switch 35S), the main CPU 71 makes an addition to a value stored in a number-of-BETs storage area provided in the RAM 73 and makes a subtraction from the value stored in the number-of-credits storage area, based on the type of the BET button (step S46).

The main CPU 71 then determines whether or not the value stored in the number-of-BETs storage area is at its maximum (step S47). When the main CPU 71 determines that the value stored in the number-of-BETs storage area is at its maximum, the main CPU 71 prohibits updating of the value stored in the number-of-BETs storage area (step S48). After step S48 or when determining in step S47 that the value stored in the number-of-BETs storage area is not at its maximum, the main CPU 71 permits operation acceptance of the spin button 31 (step S49).

After step S49 or when determining in step S45 that the operation of any of the BET buttons has not been detected, or when determining in step S43 that the value stored in the number-of-credits storage area is zero, the main CPU 71 determines whether or not operation of the spin button 31 has been detected (step S50). When the main CPU 71 determines that the operation of the spin button 31 has not been detected, the processing is shifted to step S41.

When the main CPU 71 determines that the operation of the spin button 31 has been detected, the main CPU 71 conducts jackpot-related processing which is described later with reference to FIG. 12 (step S51). In the processing, the amount to be accumulated to the amount of jackpot is calculated, and the amount is transmitted to the external control device 200.

Next, the main CPU 71 conducts insurance-related processing which is described later with reference to FIG. 11 (step S52). In the processing, counting of the number of games is conducted which triggers a payout by the insurance. After the processing has been conducted, the coin-insertion/start-check processing is completed.

### <Jackpot-Related Processing>

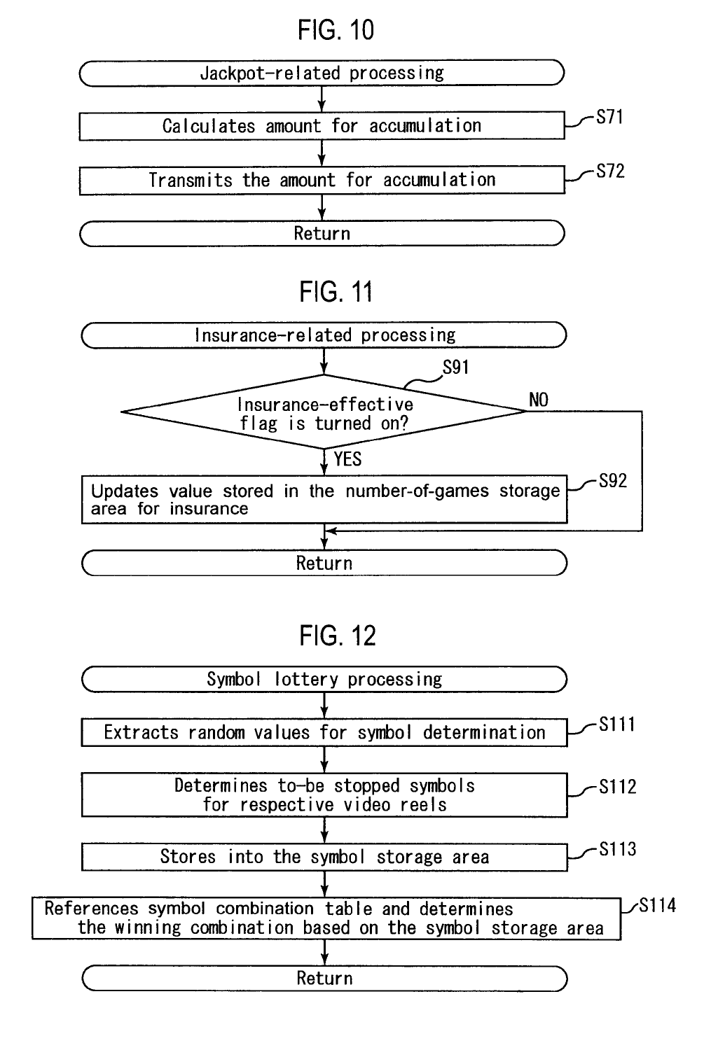

Now, with reference to FIG. 10, the jackpot-related processing in step S51 shown in FIG. 9 is described. FIG. 10 is a view illustrating a flowchart of the jackpot-related processing for the gaming machine according to the first embodiment of the present invention.

First, the main CPU 71 calculates the amount for accumulation (step S71). The main CPU 71 obtains the product of the value stored in the number-of-BETs storage area and a preset accumulation ratio, so that the amount for accumulation to the amount of jackpot is calculated.

Next, the main CPU 71 transmits the calculated amount for accumulation to the external control device 200 (step S72). Upon reception of the amount for accumulation, the external control device 200 updates the amount of jackpot. After the processing has been conducted, the jackpot-related processing is completed.

### <Insurance-Related Processing>

Next, with reference to FIG. 11, the insurance-related processing in step S52 shown in FIG. 9 is described. FIG. 11 is a view illustrating a flowchart of the insurance-related processing for the gaming machine according to the first embodiment of the present invention.

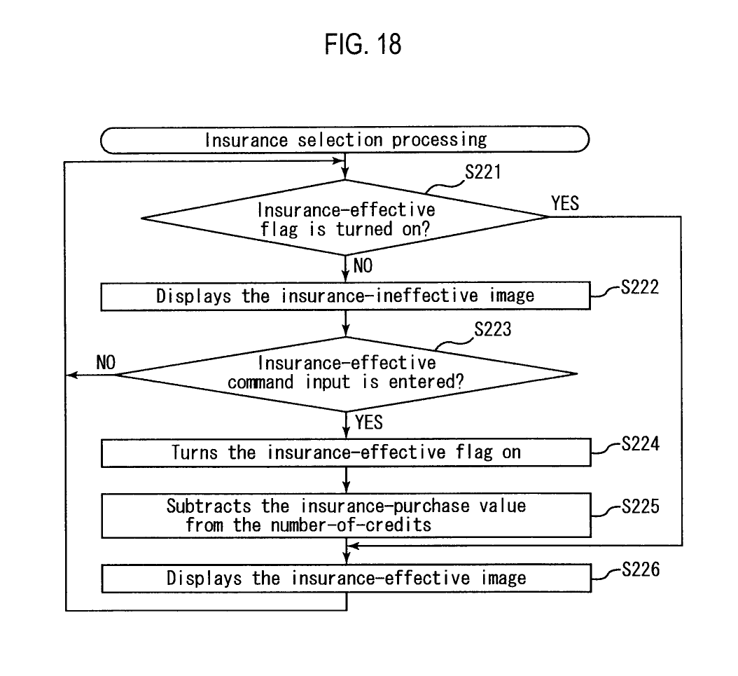

First, the main CPU 71 determines whether or not an insurance-effective flag is turned on (step S91). The insurance-effective flag is turned on when a command to make the insurance effective is inputted by the player in the insurance selection processing which is described later with reference to FIG. 18.

When the main CPU 71 determines that the insurance-effective flag is not turned on, the main CPU 71 completes the insurance-related processing. On the other hand, when the main CPU 71 determines that the insurance-effective flag is turned on, the main CPU 71 updates a value stored in a number-of-games storage area for insurance provided in the RAM 73 (step S92). The number-of-games storage area for insurance is an area for storing the number of games up to the time of the payout by the insurance. In the processing of step S92, the main CPU 71 adds one to the value stored in the number-of-games storage area for insurance. After the processing has been conducted, the insurance-related processing is completed.

### <Symbol Lottery Processing>

Next, with reference to FIG. 12, the symbol lottery processing in step S14 shown in FIG. 8 is described. FIG. 12 is a view illustrating a flowchart of the symbol lottery processing for the gaming machine according to the first embodiment of the present invention.

First, the main CPU 71 extracts random values for symbol determination (step S111). The main CPU 71 then determines to-be stopped symbols for the respective video reels 3 by lottery (step S112). The main CPU 71 holds a lottery for each video reel 3, and determines any one of the 22 symbols (code numbers from “00” to “21”) as a to-be stopped symbol. At this time, each of the 22 symbols (code numbers from “00” to “21”) is determined at an equal probability (i.e. 1/22).

The main CPU 71 then stores the determined to-be stopped symbols for the respective video reels 3 into a symbol storage area provided in the RAM 73 (step S113). Next, the main CPU references the symbol combination table (FIG. 7) and determines a winning combination based on the symbol storage area (step S114). The main CPU 71 determines whether or not the combination of symbols to be displayed along the winning line by the respective video reels 3 matches any of the combinations of symbols specified by the symbol combination table, and determines the winning combination. After the processing has been conducted, the symbol lottery processing is completed.

### <Symbol Display Control Processing>

Next, with reference to FIG. 13, the symbol display control processing in step S17 shown in FIG. 8 is described. FIG. 13 is a view illustrating a flowchart of the symbol display control processing for the gaming machine according to the first embodiment of the present invention.

First, the main CPU 71 starts scrolling of the symbol arrays of the respective video reels 3 that are displayed to the symbol display region 4 of the lower image display panel 141 (step S131). The main CPU 71 then stops the scrolling of the symbol arrays of the respective video reels 3, based on the aforementioned symbol storage area (step S132). After the processing has been conducted, the symbol display control processing is completed.

### <Number-of-Payouts Determination Processing>

Next, with reference to FIG. 14, the number-of-payouts determination processing in step S18 shown in FIG. 8 is described. FIG. 14 is a view illustrating a flowchart of the number-of-payouts determination processing for the gaming machine according to the first embodiment of the present invention.

The main CPU 71 first determines whether or not the winning combination is the jackpot (step S151). When the main CPU 71 determines that the winning combination is not the jackpot, the main CPU 71 determines the number of payouts corresponding to the winning combination (step S152). For example, when the winning combination is “BELL”, the main CPU 71 determines “8” as the number of payouts (see FIG. 7). It is to be noted that the main CPU 71 determines “0” as the number of payouts in the case where the game is lost. Next, the main CPU 71 stores the determined number of payouts into the number-of-payouts storage area (step S153). After the processing has been conducted, the number-of-payouts determination processing is completed.

When the main CPU 71 determines that the winning combination is the jackpot, the main CPU 71 notifies the external control device 200 of the winning of the jackpot (step S154). It is to be noted that, upon reception of the notification, the external control device 200 transmits to the gaming machine 1 the amount of jackpot having updated up to that time. At this time, a part (e.g. 80%) of the amount of jackpot may be the payout subject and the rest (e.g. 20%) may be carried over for the upcoming establishment of the jackpot trigger.

Next, the main CPU 71 receives the amount of jackpot from the external control device 200 (step S155). The main CPU 71 then stores the received amount of jackpot into the number-of-payouts storage area (step S156). After the processing has been conducted, the number-of-payouts determination processing is completed.

### <Insurance-Check Processing>

Next, with reference to FIG. 15, the insurance-check processing in step S23 shown in FIG. 8 is described. FIG. 15 is a view illustrating a flowchart of the insurance-check processing for the gaming machine according to the first embodiment of the present invention.

First, the main CPU 71 determines whether or not the insurance-effective flag is turned on (step S171). When the main CPU 71 determines that the insurance-effective flag is not turned on, the main CPU 71 completes the insurance-check processing.

When the main CPU 71 determines that the insurance-effective flag is turned on, the main CPU 71 determines whether or not a predetermined winning combination has been established (step S172). In the present embodiment, “bonus game trigger”, “jackpot” and “mystery bonus” are subjects of the predetermined winning combination.

When the main CPU 71 determines that the predetermined winning combination has not been established, the main CPU 71 determines whether or not the value stored in the number-of-games storage area for insurance has reached a predetermined number of times (e.g. 300) (step S173). When the main CPU 71 determines that the value stored in the number-of-games storage area for insurance has not reached the predetermined number of times, the main CPU 71 completes the insurance-check processing.

When the main CPU 71 determines that the value stored in the number-of-games storage area for insurance has reached the predetermined number of times, the main CPU 71 conducts payout processing based on the amount of insurance (step S174). The main CPU 71 adds an amount (e.g. 200) previously set as the amount of insurance to the value stored in the number-of-credits storage area.

After step S174 or when determining in step S172 that the predetermined winning combination has been established, the main CPU 71 resets the value stored in the number-of-games storage area for insurance (step S175). Next, the main CPU 71 turns the insurance-effective flag off (step S176). After this process has been conducted, the insurance-check processing is completed.

### <Bonus Game Processing>

Next, with reference to FIG. 16, the bonus game processing in step S20 shown in FIG. 8 is described. FIG. 16 is a view illustrating a flowchart of the bonus game processing for the gaming machine according to the first embodiment of the present invention.

The main CPU 71 first determines the number of bonus games (step S191). The main CPU 71 extracts a random value for number-of-bonus-games determination, and determines any one of the various numbers of bonus games such as “50”, “70” and “100” by lottery.

Next, the main CPU 71 stores the determined number of bonus games into a number-of-bonus-games storage area provided in the RAM 73 (step S192).

The main CPU 71 then conducts at-one-game-end initialization processing in the same way as the processing of step S12 described with reference to FIG. 8 (step S193). The main CPU 71 then conducts the symbol lottery processing described with reference to FIG. 12 (step S194). Then, the main CPU 71 conducts the effect contents determination processing in the same way as the processing of step S16 described with reference to FIG. 8 (step S195). Next, the main CPU 71 conducts the symbol display control processing described with reference to FIG. 13 (step S196). The main CPU 71 then conducts the number-of-payouts determination processing described with reference to FIG. 14 (step S197).

Next, the main CPU 71 determines whether or not the bonus game trigger has been established (step S198). When the main CPU 71 determines that the bonus game trigger has been established, determination of the number of bonus games to be added is conducted (step S199). The determination is conducted in the same way as the aforementioned processing of step S191. The main CPU 71 then adds the determined additional number of bonus games to the value stored in the number-of-bonus-games storage area (step S200).

After the processing of step S200 or when determining in step S198 that the bonus game trigger has not been established, the main CPU 71 conducts the payout processing (step S201). In the payout processing, the main CPU 71 adds the value stored into the number-of-payouts storage area in the aforementioned number-of-payouts determination processing of step S197 to a value stored in a number-of-payouts storage area for bonus. The number-of-payouts storage area for bonus is an area for storing a total of the numbers of payouts determined during the bonus games.

When the bonus game processing has been completed, the main CPU 71 adds the value stored in the number-of-payouts storage area for bonus to the value stored in the number-of-credits storage area provided in the RAM 73, in the payout processing of step S24 described with reference to FIG. 8. That is, the total of the numbers of payouts determined during the bonus games is collectively paid out. Here, it is to be noted that coins may be discharged from the coin payout exit 15A, or a ticket with a barcode may be issued.

Next, the main CPU 71 subtracts one from the value stored in the number-of-bonus-games storage area (step S202). Next, the main CPU 71 determines whether or not the value stored in the number-of-bonus-games storage area is zero (step S203). When the main CPU 71 determines that the value stored in the number-of-bonus-games storage area is not zero, the main CPU 71 shifts the processing to step S193. On the other hand, when the main CPU 71 determines that the value stored in the number-of-bonus-games storage area is zero, the main CPU 71 completes the bonus game processing. When the bonus game processing has been completed, the processing is shifted to the processing of step S21 described with reference to FIG. 8.

### <Payout Rate Update Processing>

Next, with reference to FIG. 17, the payout rate update processing in step S25 shown in FIG. 8 is described. FIG. 17 is a view illustrating a flowchart of payout rate update processing for the gaming machine according to the first embodiment of the present invention.

First, the main CPU 71 determines whether or not it is a cycle time to update the payout rate (step S211). The update cycle time of the payout rate comes when the number of executed games of the basic game reaches the preset number of games after the last update of the payout rate. When the main CPU 71 determines that it is not the update cycle time of the payout rate, the payout update processing is completed.

When the main CPU 71 determines that it is the update cycle time of the payout rate, the main CPU 71 detects the current playing state of the gaming machine 1 (step S212). The current playing state is determined according to the average number of BETs placed during the preset number of latest basic games.

When the average number of BETs is fewer than that of the maximum BET, the current playing state detected by the main CPU 71 becomes “the fewer-than maximum BET”. In a case where the average number of BETs is that of the maximum BET, the current playing state detected by the main CPU 71 becomes the “the maximum BET” when the insurance is ineffective or becomes “the insurance-effective” when the insurance is effective.

Next, the main CPU 71 updates the payout rates to be applied to the following basic games to the payout rates corresponding to the current playing state detected in step S212 (step S213).

Next, the main CPU 71 updates display contents of the payout rate display portion 132 to contents with the payout rates updated in step S213 (step S214). After this process is conducted, the payout rate update processing is competed.

When the payout rate updated in step 213 is “the fewer-than maximum BET”, the main CPU 71 displays the area 132a assigned to the playing state “the fewer-than maximum BET” with the red background color. In addition, the areas 132b and 132c assigned to the other playing states are displayed with the blue background color. When the payout rate updated in step 213 is “the maximum BET”, the main CPU 71 displays the area 132b assigned to the playing state “maximum BET” with the red background color. In addition, the areas 132a and 132c assigned to the other playing states are displayed with the blue background color. When the payout rate updated in step 213 is “the insurance-effective”, the main CPU 71 displays the area 132c assigned to the playing state “insurance-effective” with the red background color. In addition, the areas 132a and 132c assigned to the other playing states are displayed with the blue background color. Namely, the main CPU 71 assigns the color data of red as the background color in the area 132a to 132c displaying the payout rate applied to the current basic game from the color pallet data in the game program stored in the RAM 73 of the mother board 70. In addition, the main CPU 71 assigns the color data of blue as the background color in the other areas 132a to 132c from the color pallet data.

### <Insurance Selection Processing>

Next, with reference to FIG. 18, the insurance selection processing is described. FIG. 18 is a view illustrating a flowchart of the insurance selection processing for the gaming machine according to the first embodiment of the present invention.

First, the main CPU 71 determines whether or not the insurance-effective flag is turned on (step S221). When the main CPU 71 determines that the insurance-effective flag is not turned on, the main CPU 71 displays an insurance-ineffective image (step S222). The main CPU 71 transmits a command to display the insurance-ineffective image to the graphic board 130. Based on the command, the graphic board 130 generates the insurance-ineffective image and displays the image to the lower image display panel 141.

As the insurance-ineffective image, for example, an image showing “INSURANCE BET $1.00 TOUCH TO BET” is displayed. This image is an image for prompting the player to select whether or not to make the insurance effective, and notifying the player of the amount required for making the insurance effective. The player can input a command to make the insurance effective by touching a predetermined place on the touch panel 114.

Subsequently, the main CPU 71 determines whether or not an insurance-effective command input has been entered via the insurance set switch 37S (step S223). When the main CPU 71 determines that the insurance-effective command input has not been entered, the main CPU 71 shifts the processing to step S221 with the insurance-effective flag turned off. On the other hand, when the main CPU 71 determines that the insurance-effective command input has been entered, the main CPU 71 turns the insurance-effective flag on (step S224).

Next, the main CPU 71 subtracts the insurance-purchase amount from the value stored in the number-of-credits storage area (step S225). In the present embodiment, an amount corresponding to, for example, one dollar is subtracted from the value stored in the number-of-credits storage area. After step S225 or when determining in step S221 that the insurance-effective flag is turned on, the main CPU 71 displays the insurance-effective image (step S226).

As the insurance-effective image, for example, an image showing “INSURANCE CONTINUED WIN 200 CREDIT” is displayed. This image is an image informing the player that the insurance is effective, and that the value of “200” is to be added to the value stored in the number-of-credits storage area when the insurance condition is satisfied. After the processing has been conducted, the processing is shifted to step S221.

According to the above-described gaming machine 1 of the present embodiment, the playing state of the basic game is set based on the average number of BETs placed by operations of the 1-BET button 34 or the maximum BET button 35 and presence/absence of an operation of the insurance set button 37. Then, the basic game with the set playing state is started when the spin button 31 is operated. In addition, during the basic game, the payout rate applied to the basic game is displayed in the payout rate display portion 132 on the upper image display panel 131. Specifically, the area 132a to 132c corresponding to the set playing state is displayed with the red background color during the basic game among the plural areas 132a to 132c of the payout rate display portion 132. The payout rates to be applied to the basic game are displayed in the areas 132a to 132c. The other areas 132a to 132c are displayed with the blue background color during the basic game.

Therefore, according to the gaming machine 1 of the present embodiment, it can be done to inform the player of the current playing state of the gaming machine 1 and the payout rate applied to the basic game through the background color in the areas 132a to 132c of the payout rate display portion 132.

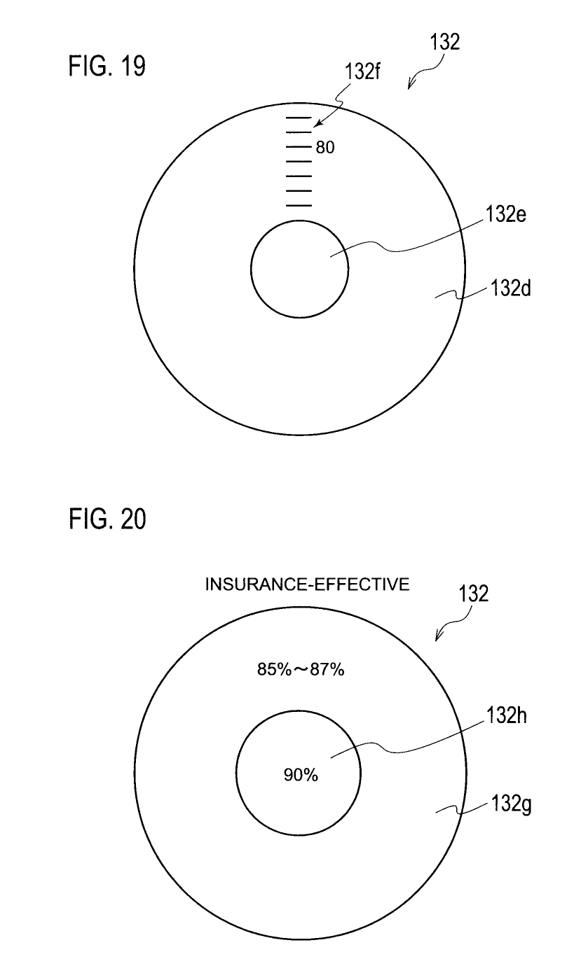

Note that the payout rate display portion 132 may have a different configuration from the configuration with the three areas 132a to 132c as shown in FIG. 1. For example, in a modified example shown in FIG. 19, the payout rate display portion 132 is segmented into two areas 132d and 132e by two concentric circles. The outer area 132d corresponds to the playing state “fewer-than maximum BET”, and the inner area 132e corresponds to the playing state “maximum BET”. The outer area 132d includes a gauge 132f that indicates the payout rate.

Then, when the current playing state is “the fewer-than maximum BET”, both of the outer and inner areas 132d and 132e are displayed. The payout rates applied to the basic game is indicated by the position of an outline of the outer area 132d along the gauge 132f. Therefore, when the payout rate changes, the size of the area 132d displayed on the payout display portion 132 also changes. Note that the state shown in FIG. 19 indicates that that the payout rate is 74%.

In addition, when the current playing state is “the maximum BET”, only the inner area 132e is displayed. In this case, the outline of the inner area 132e is on 90% of the gauge 132f (the gauge may be visible or invisible). Namely, the payout rate with the playing state “maximum BET” is 90%.

Here, when the current playing state is “the fewer-than maximum BET” or “the maximum BET”, the both areas 132d and 132e are displayed with the blue background color. When the current playing state is “the insurance-effective”, only the inner area 132e is displayed with the red background color. The payout rate with the playing state “insurance-effective” may be indicated on a blank space in the area 132d or 132e with its value (95%), or not be indicated.

FIG. 20 is a view illustrating a payout rate display portion in the gaming machine according to another modified example of the first embodiment. In the other modified example shown in FIG. 20, the payout rate display portion 132 is segmented into two areas 132g and 132h by two concentric circles. The outer area 132g corresponds to the playing state “fewer-than maximum BET”, and the inner area 132h corresponds to the playing state “maximum BET”. Each value indicated in the areas 132g and 132h indicates the payout rates corresponding thereto.

Then, when the current playing state is “the fewer-than maximum BET”, the outer area 132d is displayed with the red background color and the inner area 132h is displayed with the blue background color. In addition, when the current playing state is “the maximum BET”, the outer area 132g is displayed with the blue background color and the inner area 132h is displayed with the red background color. When the current playing state is “the insurance-effective”, a text string “INSURANCE EFFECTIVE” is displayed on a blank space outside the area 132d or 132e in addition to the presentation of the playing state “maximum BET”. The payout rate with the playing state “insurance-effective” is indicated in the inner area 132h similarly to the case of the playing state “maximum BET”. The payout rate with the playing state “insurance-effective” (e.g. 95%) is higher than that with the playing state “maximum BET” (e.g. 90%).

According to these modified examples, similarly to the gaming machine 1 in the first embodiment, it can be done to inform the player of the current playing state of the gaming machine 1 and the payout rate applied to the basic game through the background color in the areas 132d, 132e, 132g and 132h of the payout rate display portion 132.

In the above-described present embodiment and its modified examples, the playing state of the basic game is set and the payout rate to be applied to the basic game is determined, based on the average number of BETs and the effective/ineffective state of the insurance. However, the playing state and the payout rate to be applied may be determined for each basic game based on the number of BETs and the effective/ineffective state of the insurance.

### Second Embodiment

Hereinafter, a second embodiment according to the present embodiment will be described. In the second embodiment, the playing state and the payout rate to be applied may be determined for each basic game based on the number of BETs and the effective/ineffective state of the insurance.

### [Contents of Program]

### <Main Control Processing>

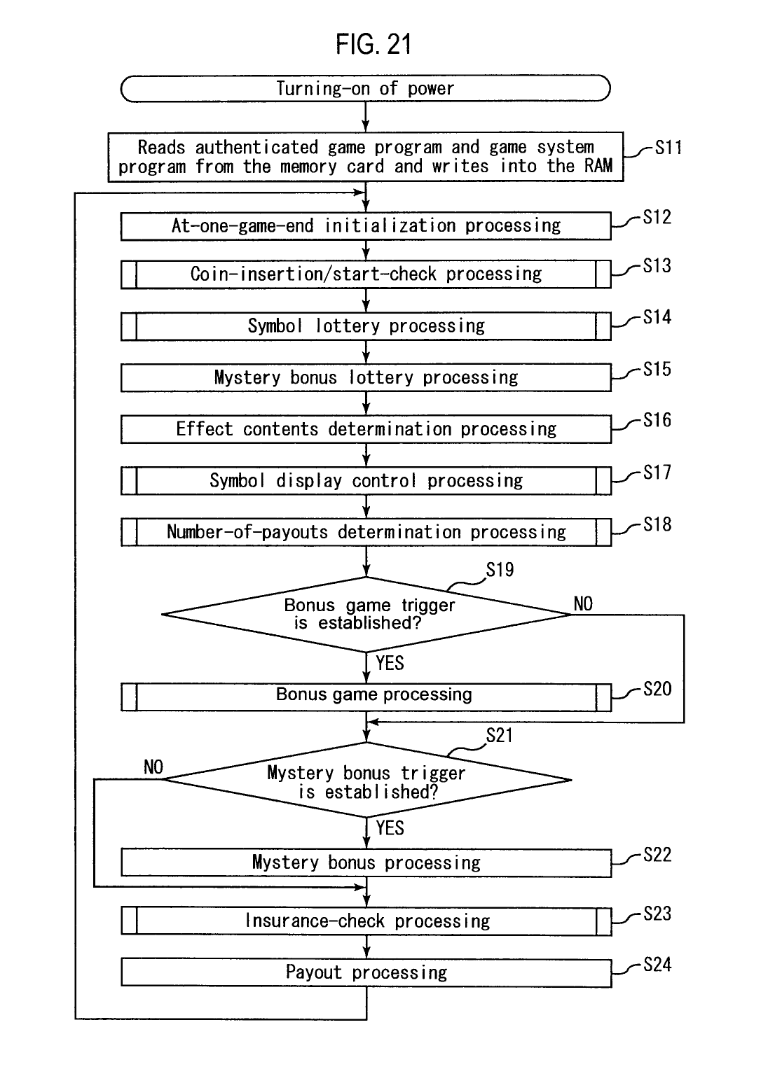

In the second embodiment, the contents of the main control processing is changed as shown in FIG. 21 from those of the gaming machine 1 in the first embodiment shown in FIG. 8. Here, the payout rate update processing in step S25 is omitted in the present embodiment from the contents of the main control processing (steps S11 to S25) in the first embodiment.

### <Coin-Insertion/Start-Check Processing>

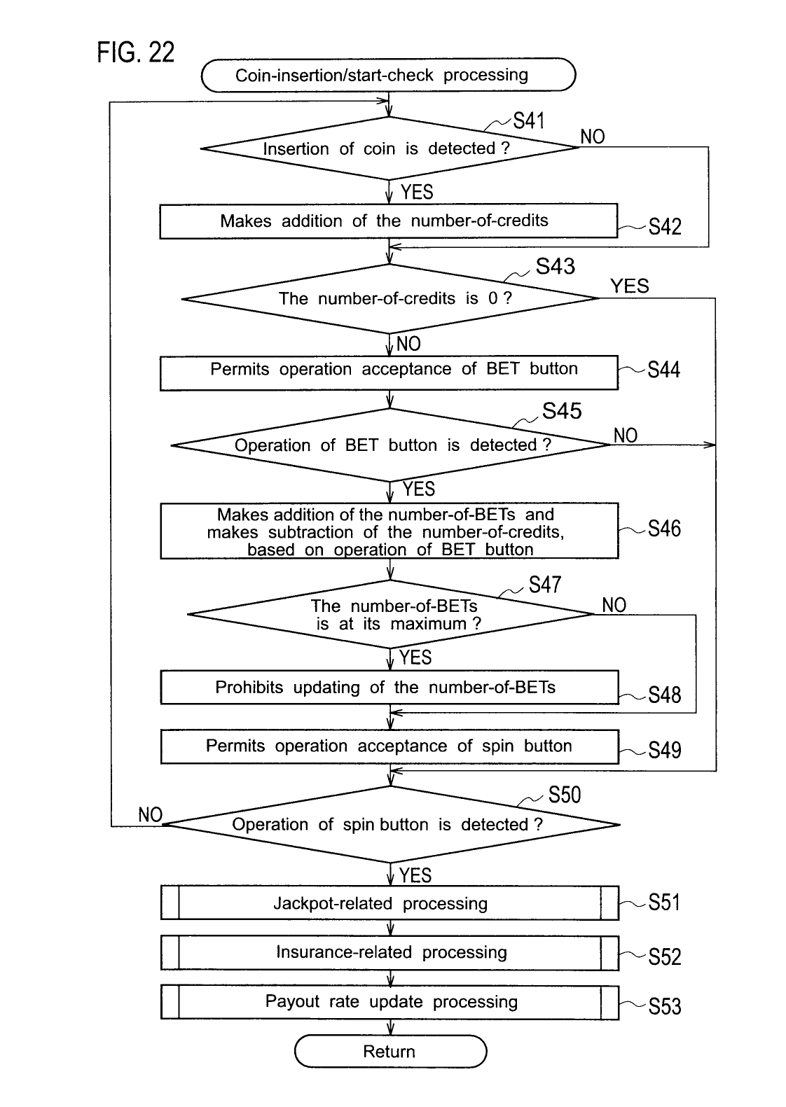

In the second embodiment, the payout rate update processing (step S53) is conducted in the coin-insertion/start-check processing (step S13 in FIG. 21) as shown in FIG. 22 after executing the same processes (steps S41 to S52) in the first embodiment.

### <Payout Rate Update Processing>

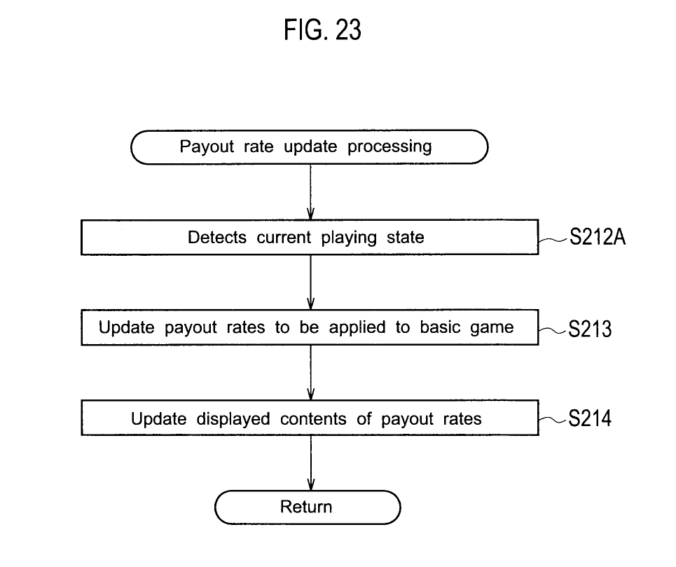

Next, with reference to FIG. 23, the payout rate update processing in step S53 shown in FIG. 22 is described. FIG. 23 is a view illustrating a flowchart of the payout rate update processing for the gaming machine according to the second embodiment of the present invention.

As shown in FIG. 23, the main CPU 71 conducts a process of step S212A instead of the processes of steps S211 and S212 shown in FIG. 17 in the first embodiment. After the execution of step S212A, the main CPU 71 conducts the same processes 5213 and S214 in the first embodiment.

Specifically, the main CPU 71 detects the current playing state of the gaming machine 1 in step S212A. The current playing state is detected based on whether or not the value stored in the number-of-BETs storage area is maximal and whether or not the insurance-effective flag is turned on. When the value stored in the number-of-BETs storage area is not maximal, the current playing state detected by the main CPU 71 is “the fewer-than maximum BET”. In a case where the value stored in the number-of-BETs storage area is maximal, the insurance is not effective, the current playing state detected by the main CPU 71 becomes “the maximum BET” when the insurance-effective flag is turned off or become “the insurance-effective” when the insurance-effective flag is turned on.

After the above-mentioned step S212A, the main CPU 71 updates the payout rate to be applied to the next basic game to the payout rate corresponding to the current playing state detected in step S212A (step S213).

Next, the main CPU 71 updates display contents of the payout rate display portion 132 to contents with the payout rates updated in step S213 (step S214). After this process is conducted, the payout rate update processing is competed.

According to the gaming machine 1 of the second embodiment, it can be done to inform the player of the current playing state of the gaming machine 1 and the payout rate applied to the basic game through the background color in the areas 132a to 132c of the payout rate display portion 132.

Note that, in the above-described second embodiment, BETs on the basic games are placed by operating the 1-BET button 34 and the maximum BET button 35, and the insurance is made effective by operating the insurance set button 37. However, the BETs may be placed and the insurance may be made effective by a touching operation on the payout rate display portion 132 on the upper image display panel 131.

### Third Embodiment

Hereinafter, a third embodiment according to the present embodiment will be described. In the third embodiment, the BETs on the basic games can be placed and the insurance can be made effective by a touching operation on the payout rate display portion 132.

### [Overall Configuration of Gaming Machine]

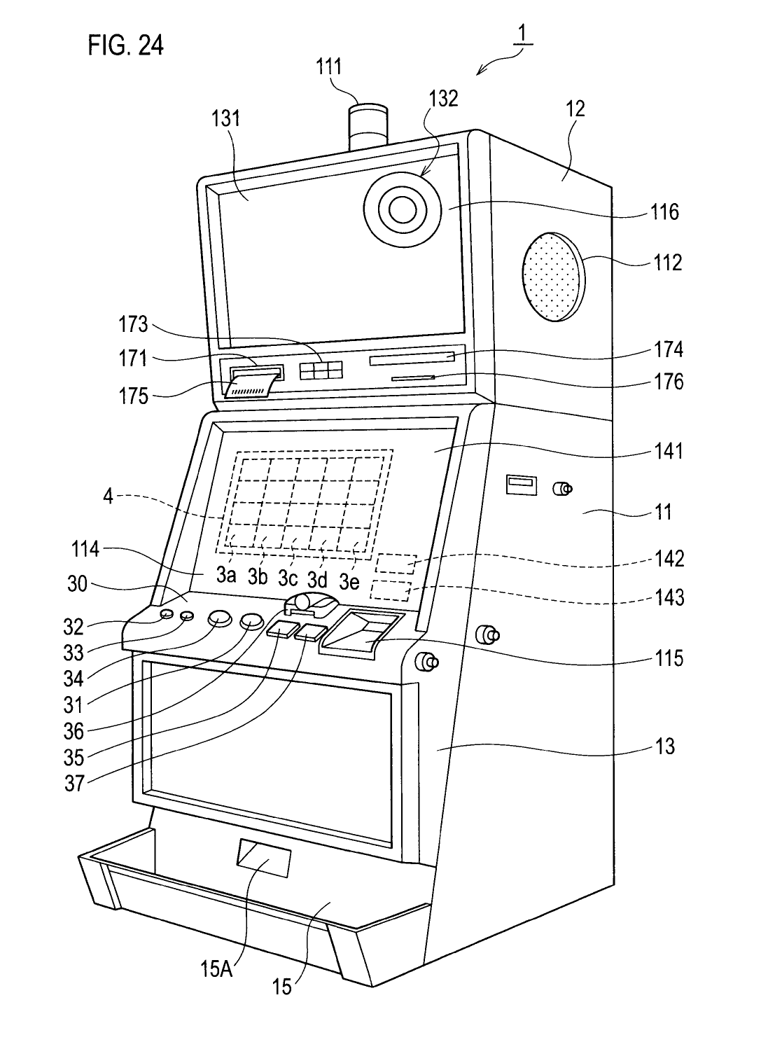

First, with reference to FIG. 24, an overall configuration of the gaming machine 1 according to the third embodiment of the present invention is described. FIG. 24 is a view illustrating the overall configuration of the gaming machine according to the third embodiment of the present invention. In the gaming machine 1 in the third embodiment, a touchscreen (touch sensor) 116 is installed on the upper image display panel 131 of the gaming machine 1 in the first embodiment. Other configurations of the gaming machine 1 in the third embodiment are the same as those of the gaming machine 1 in the first embodiment.

### [Configuration of Circuit Included in Gaming Machine]

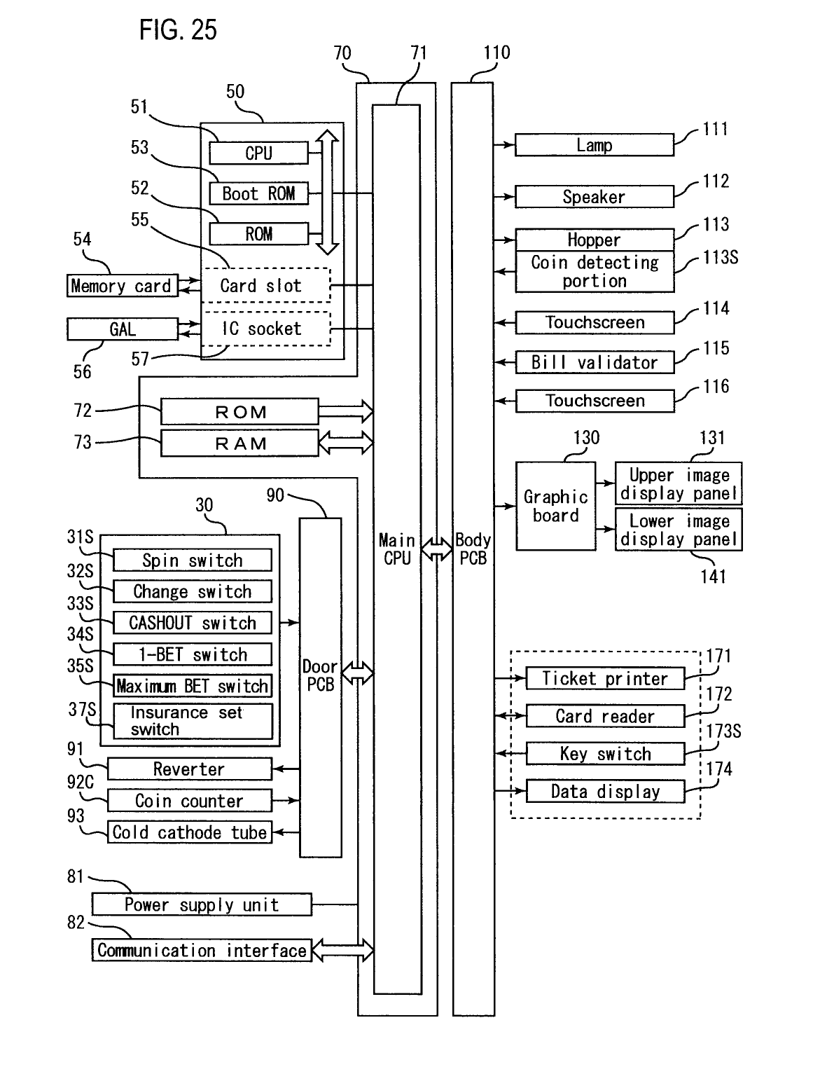

Next, with reference to FIG. 25, a configuration of a circuit included in the gaming machine 1 is described. FIG. 25 is a block diagram illustrating an internal configuration of the gaming machine according to the third embodiment of the present invention.

The touchscreen 116 installed on the upper image display panel 131 is connected with the body PCB 110 as shown in FIG. 25. The touchscreen 116 detects a position on the upper image display panel 131 that is touched by a player's finger or the like and outputs a signal corresponding to the detected position to the main CPU 71.

### [Contents of Program]

### <Main Control Processing>

In the gaming machine 1 in the third embodiment, conducted are the same processes as those in the main control processing conducted by the gaming machine 1 in the second embodiment (FIG. 21, steps S11 to S24).

### <Coin-Insertion/Start-Check Processing>

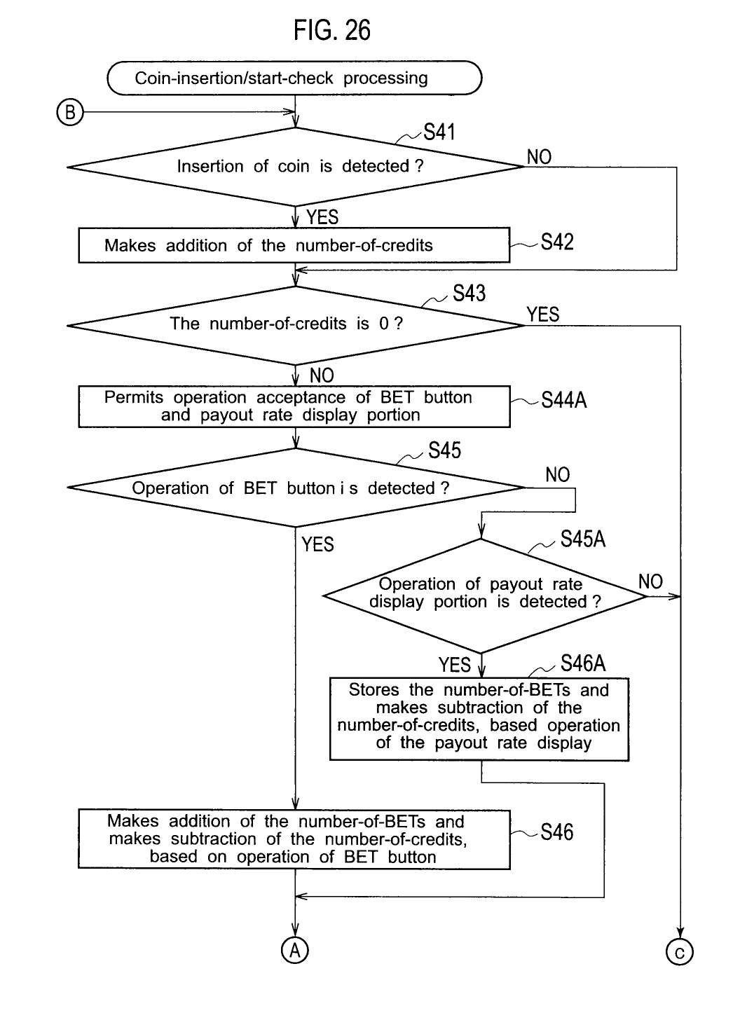

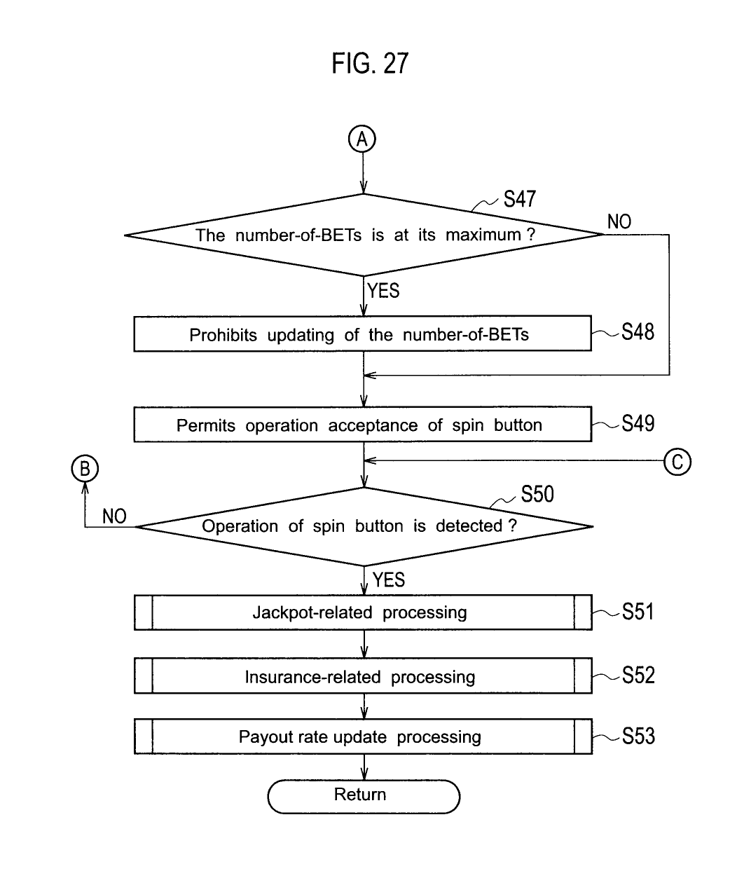

In the third embodiment, as shown in FIGS. 26 and 27, conducted are processes that are partly changed from those in the coin-insertion/start-check processing conducted by the gaming machine 1 in the second embodiment (FIG. 22).

First, as shown in FIG. 26, the main CPU 71 conducts the same processes as those in steps S41 to S43 shown in FIG. 22. When the main CPU 71 determines that the value stored in the number-of-credits storage area is not zero, the main CPU 71 permits operation acceptance of the BET buttons (the 1-BET button 34, the maximum BET button 35) and the payout rate display portion 132 (step S44A).

Next, the main CPU 71 determines whether or not operation of any of the BET buttons has been detected (step S45). When the main CPU 71 detects the player's pressing of any of the BET buttons through the BET switches (the 1-BET switch 34S, the maximum BET switch 35S), the main CPU 71 makes an addition to a value stored in the number-of-BETs storage area provided in the RAM 73 and makes a subtraction from the value stored in the number-of-credits storage area, based on the type of the BET button (step S46).

When the main CPU 71 does not detect the player's pressing of any of the BET buttons through the BET switches (the 1-BET switch 34S, the maximum BET switch 35S), the main CPU 71 determines whether or not operation of any of the areas 132a to 132c of the payout rate display portion 132 has been detected (step S45A). When the main CPU 71 detects the player's touching operation of any of the areas 132a to 132c of the payout rate display portion 132 through the touchscreen 116, the main CPU 71 stores the number of BETs corresponding to the touched area 132a to 132c in the number-of-BETs storage area provided in the RAM 73 and makes a subtraction from the value stored in the number-of-credits storage area (step S46A).

Specifically, when the main CPU 71 detects the touching operation on the area 132a corresponding to the playing state “fewer-than maximum BET”, the main CPU 71 stores the number of BETs corresponding to “the fewer-than maximum BET” in the number-of-BETs storage area and makes a subtraction from the value stored in the number-of-credits storage area. The number of BETs corresponding to “the fewer-than maximum BET” can be set to an arbitrary value between “1” to “(the number of maximum BET)-1”. When the main CPU 71 detects the touching operation on the area 132b corresponding to the playing state “maximum BET”, the main CPU 71 stores the number of maximum BET in the number-of-BETs storage area and makes a subtraction from the value stored in the number-of-credits storage area. When the main CPU 71 detects the touching operation on the area 132c corresponding to the playing state “insurance-effective”, the main CPU 71 stores the total number of the number of maximum BET and the number of BETs for making the insurance effective in the number-of-BETs storage area and makes a subtraction from the value stored in the number-of-credits storage area.

After step S46 or S46A, the main CPU 71 conducts the same processes as those in steps S47 to S53 in FIG. 22 as shown in FIG. 27.

### <Insurance Selection Processing>

In the gaming machine 1 in the third embodiment, in step S223 in the insurance selection processing shown in FIG. 18, after-mentioned two inputs are monitored when determining whether or not the insurance-effective command input has been entered. One of the monitored inputs is an input from the insurance set switch 37S along with the operation of the insurance set button 37. Another of the monitored input is an input from the touchscreen 116 along with the touching operation of the area 132c in the payout rate display portion 132 corresponding to the playing state “insurance-effective”. When the main CPU detects any one of the monitored two inputs, the main CPU 71 determines that the insurance-effective command input has been entered.

According to the gaming machine 1 of the third embodiment, it can be done to inform the player of the current playing state of the gaming machine 1 and the payout rate applied to the basic game through the background color in the areas 132a to 132c of the payout rate display portion 132.

In addition, according to the gaming machine 1 of the third embodiment, when any of the areas 132a to 132c of the payout rate display portion 132 is touch-operated, the playing state of the basic game is set to the playing state corresponding to the touch-operated area 132a to 132c. Then the touch-operated area 132a to 132c is displayed with the red background color and other areas 132a to 132c are displayed with the blue background color. Therefore, the player easily set one playing state to play the basic game with a desired payout rate while seeing the payout rates displayed at the payout rate display portion 132.

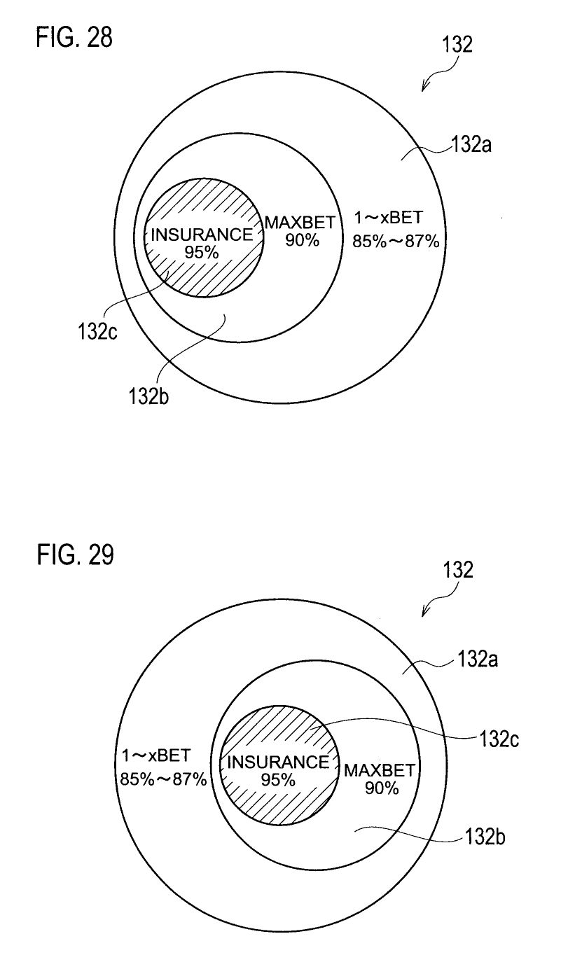

Note that the areas 132a to 132c of the payout rate display portion 132 may be segmented by the nested eccentric circles as shown in modified examples of the payout rate display portion 132 (FIGS. 28 and 29). According to this configuration, wide spaces can be provided between adjacent two circles for touching. Therefore, the player can easily touch the wide spaces in the areas 132a to 132c to set the playing state and thereby an incorrect touch-operation can be prevented. Note that the touchscreen (touch sensor) 116 can be adopted with the payout rate display portion 132 segmented by the concentric circles as shown in FIGS. 1, 19 and 20 in order to easily-select the playing state while seeing the payout rates displayed at the payout rate display portion 132.

In the gaming machine 1 in the above-described first to third embodiments and their modified examples, the gaming machine 1 determines by itself whether or not the condition for providing a payout of the insurance is established. However, it may be determined by the external control device 200 (FIG. 3) whether or not the condition for providing a payout of the insurance is established.

### Fourth Embodiment

Hereinafter, a fourth embodiment according to the present embodiment will be described. In the fourth embodiment, it is determined by the external control device 200 whether or not the condition for providing a payout of the insurance is established.

### [Contents of Program]

### <Insurance-Related Processing>

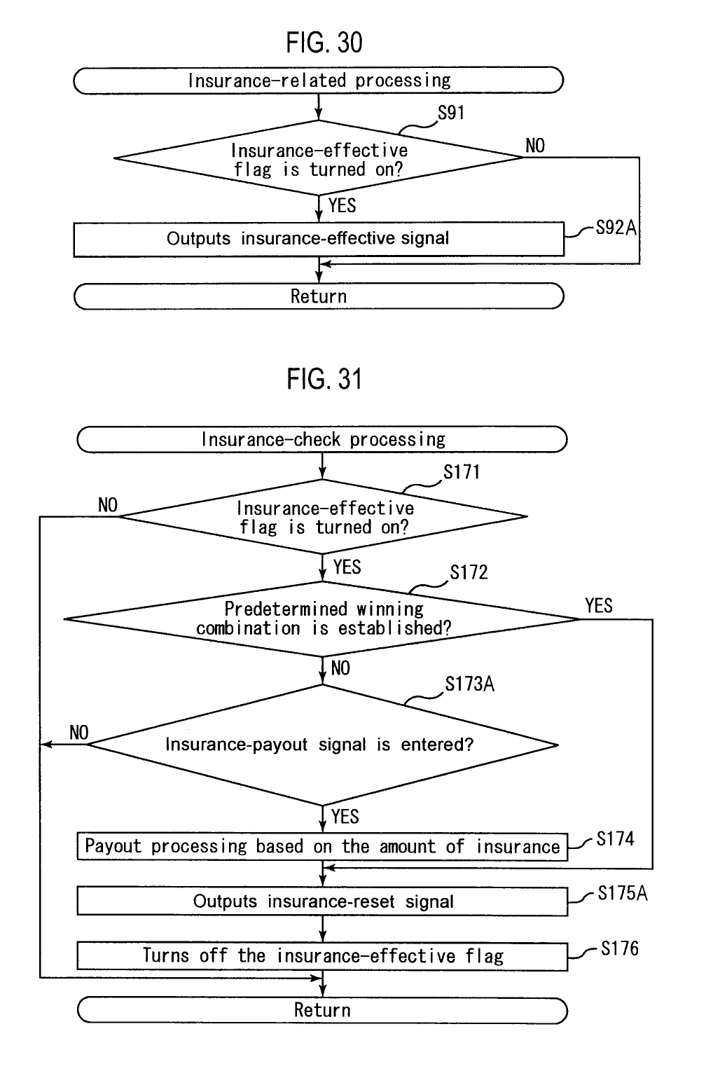

In the gaming machine 1 in the fourth embodiment, a process of step S92A shown in FIG. 30 is conducted instead of the process of step S92 shown in FIG. 11 in the first embodiment. Then, the main CPU 71 outputs an insurance-effective signal to the external control device 200 in step S92A. After this process has been conducted, the insurance-related processing is completed.

### <Insurance-Check Processing>

In addition, in the gaming machine 1 in the fourth embodiment, processes of steps S173A and S175A shown in FIG. 31 are conducted instead of the processes of steps S173 and 5175 shown in FIG. 15 in the first embodiment. Then, the main CPU 71 determines whether or not an insurance-payout signal has been entered from the external control device 200 in step S173A. When the main CPU 71 determines that the insurance-payout signal has not entered from the external control device 200, the main CPU 71 completes the insurance-check processing.

When the main CPU 71 determines that the insurance-payout signal has entered from the external control device 200, the main CPU 71 conducts the payout processing based on the amount of insurance (step S174). The main CPU 71 adds an amount (e.g. 200) previously set as the amount of insurance to the value stored in the number-of-credits storage area.

After step S174 or when determining in step S172 that the predetermined winning combination has been established, the main CPU 71 sends an insurance-reset signal to the external control device 200 (step S175A). Next, the main CPU 71 turns the insurance-effective flag off (step S176). After this process has been conducted, the insurance-check processing is completed.

### <Insurance-Management Processing>

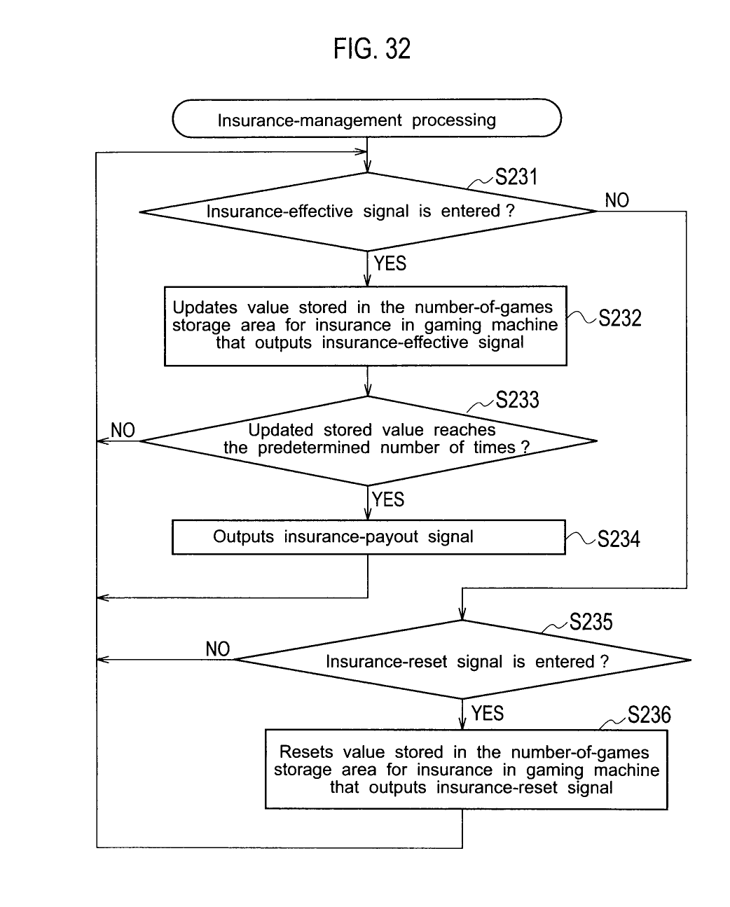

Meanwhile, the external control device 200 in the fourth embodiment conducts insurance-management processing. In the insurance-management processing, as shown in FIG. 32, the external control device 200 determines whether or not the insurance-effective signal has been entered from any of the gaming machines 1 (step S231).

When the external control device 200 determines whether or not the insurance-effective signal has not been entered from any of the gaming machines 1, the external control device 200 advances the process flow to step S235. On the other hand, when the external control device 200 determines that the insurance-effective signal has been entered from any of the gaming machines 1, the external control device 200 updates a value stored in a number-of-games storage area for insurance corresponding to the gaming machine 1 that has sent the insurance-effective signal among number-of-games storage areas for insurance provided in a RAM of the external control device 200 (step S232). The number-of-games storage area for insurance is provided for each of the gaming machines 1 to store the number of played games until a payout of the insurance is provided. The external control device 200 adds “1” to the value stored in the number-of-games storage area(s) for insurance corresponding to the gaming machines) 1 that has sent the insurance-effective signal in the process of step S232.

Next, the external control device 200 determines whether or not the stored value after the update in step S232 reaches a preset value (e.g. 300) (step S233). When the external control device 200 determines that the stored value after the update in step S232 does not reach the preset value, the external control device 200 advances the process flow to step S231.

When the external control device 200 determines that the stored value after the update in step S232 reaches the preset value, the external control device 200 sends the insurance-payout signal to the gaming machine(s) 1 that has sent the insurance-effective signal (step S234). After this process has been conducted, the external control device 200 advances the process flow to step S231.

In addition, when the external control device 200 determines that the insurance-effective signal has not been entered from any of the gaming machines 1 in step S231, the external control device 200 determines whether or not the insurance-reset signal has entered from any of the gaming machines 1 (step S235).

When the external control device 200 determines that the insurance-reset signal has not entered from any of the gaming machines 1, the external control device 200 advances the process flow to step S231. On the other hand, when the external control device 200 determines that the insurance-reset signal has entered from any of the gaming machines 1, the external control device 200 reset the value stored in the number-of-games storage area for insurance corresponding to the gaming machine 1 that has sent the insurance-reset signal among number-of-games storage areas for insurance provided in the RAM of the external control device 200 (step S236). After this process has been conducted, the external control device 200 advances the process flow to step S231.

According to the gaming machine 1 of the fourth embodiment, it can be done to inform the player of the current playing state of the gaming machine 1 and the payout rate applied to the basic game through the background color in the areas 132a to 132c of the payout rate display portion 132.

Note that, in the above-described embodiments and their modified examples, a payout of the insurance with the insurance-effective is provided when the bonus trigger is not established continuously during the preset number (e.g. 1000 games) of basic games. However, for example, a payout of the insurance may be provided when the number of expended coins without the bonus trigger establishment reaches a preset value (e.g. 1000 coins) during the successive basic games. Here, the number of expended coins is obtained by subtracting the total number of coins paid out for winnings except the bonus game trigger from the total number of coins bet on the basic games.

Although the embodiments of the present invention were described above, they were just illustrations of specific examples, and hence do not particularly restrict the present invention. A specific configuration of each step and the like is appropriately changeable in terms of design. Further, the effects described in the embodiments of the present invention are just recitations of the most suitable effects generated from the present invention. The effects of the present invention are thus not limited to those described in the embodiments of the present invention.

Further, the foregoing detailed descriptions centered the characteristic parts of the present invention in order to facilitate understanding of the present invention. The present invention is not limited to the embodiments in the foregoing specific descriptions but applicable to other embodiments with a variety of application ranges. Further, terms and phrases in the present specification were used not for restricting interpretation of the present invention but for precisely describing the present invention. It is considered easy for the skilled in the art to conceive other configurations, systems, methods and the like included in the concept of the present invention from the concept of the invention described in the specification. Therefore, it should be considered that recitations of the claims include uniform configurations in a range not departing from the range of technical principles of the present invention. Moreover, an object of the abstract is to enable a patent office, a general public institution, an engineer belonging to the technical field who is unfamiliar with patent, technical jargon or legal jargon, and the like, to smoothly determine technical contents and an essence of the present application with simple investigation. Accordingly, the abstract is not intended to restrict the scope of the invention which should be evaluated by recitations of the claims. Furthermore, for thorough understanding of an object of the present invention and an effect specific to the present invention, it is desired to make interpretation in full consideration of documents already disclosed and the like.

The foregoing detailed descriptions include processing executed on a computer. Explanations and expressions above are described with the aim of being most efficiently understood by the skilled person in the art. In the specification, each step for use in deriving one result should be understood as the self-consistent processing. Further, in each step, transmission/reception, recording or the like of an electrical or magnetic signal is performed. While such a signal is expressed by using a bit, a value, a symbol, a letter, a term, a number or the like in processing of each step, it should be noted that those are used simply for the sake of convenience in description. While there are cases where processing in each step may be described using an expression in common with that of action of a human, processing described in the specification is essentially executed by a variety of devices. Further, other configurations requested for performing each step should become apparent from the above descriptions.

What is claimed as new and desired to be secured by Letters Patent of the United States is:

1. A gaming machine comprising;
a selection device for accepting a selection operation of one of plural playing states for a basic game;
an input device for accepting an input to start the basic game;
a display for displaying images; and
a controller operable to:
(a) set a playing state for the basic game according to the selection operation accepted by the selection device,
(b) start the basic game with the playing state set in (a) when the input is accepted by the input device,
(c) display plural payout rates for the basic game in plural areas on the display, respectively, the plural areas being allocated to the plural playing states one by one, and
(d) set, during execution of the basic game, a background color in one of the plural areas that is allocated to the playing state set in (a) to a different color from another color of backgrounds in others of the plural areas.

2. The gaming machine according to claim 1, wherein
the selection device includes a touch-sensitive sensor for detecting a touching operation on one of the plural areas on the display as the selection operation, and
the controller sets the playing state in (a) according to the one of the plural areas detected through the touch-sensitive sensor.

3. The gaming machine according to claim 2, wherein
the plural areas are segmented by plural concentric circles.

4. The gaming machine according to claim 2, wherein
the plural areas are segmented by nested plural circles that have different diameters, and
each pair of two adjacent circles among the nested plural circles is made eccentric.

5. A gaming machine comprising;
a bet switch for placing a bet on a basic game;
a mode switch for setting an insurance mode;
an input device for accepting an input to start the basic game;
a display for displaying images; and
a controller operable to:
(a) set one of plural playing states as a playing state for the basic game according to the bet placed by the bet switch and the insurance mode set by the mode switch,
(b) start the basic game with the playing state set in (a) when the input is accepted by the input device,
(c) display plural payout rates for the basic game in plural areas on the display, respectively, the plural areas being allocated to the plural playing states one by one, and
(d) set, during execution of the basic game, a background color in one of the plural areas that is allocated to the playing state set in (a) to a different color from another color of backgrounds in others of the plural areas.

6. The gaming machine according to claim 5, wherein
the bet switch and the mode switch include a touch-sensitive sensor for detecting a touching operation on one of the plural areas on the display, and
the controller sets the playing state in (a) according to the one of the plural areas detected through the touch-sensitive sensor.

7. The gaming machine according to claim 6, wherein
the plural areas are segmented by plural concentric circles.

8. The gaming machine according to claim 6, wherein
the plural areas are segmented by nested plural circles that have different diameters, and
each pair of two adjacent circles among the nested plural circles is made eccentric.

9. A gaming machine comprising;
a bet switch for placing a bet on a basic game;
a mode switch for setting an insurance mode;
an input device for accepting an input to start the basic game;
a display for displaying images for the basic game and images of plural areas that are allocated to plural playing states one by one;
an image data memory for storing basic game image data including the images for the basic game and area image data including the images of the plural areas;
a pallet memory for sorting color data of background colors in the plural areas;
a frame memory for storing video image data of the basic game and the plural areas, the video image data being generated based on the basic game image data, the area image data and the color data; and
a controller operable to:
(a) set one of the plural playing states as a playing state for the basic game according to the bet placed by the bet switch and the insurance mode set by the mode switch,
(b) start the basic game with the playing state set in (a) when the input is accepted by the input device,
(c) assign, based on the color data stored in the pallet memory, a different color from another color of backgrounds in others of the plural areas to a background color in one of the plural areas that is allocated to the playing state set in (a),
(d) display plural payout rates for the basic game in the plural areas on the display, respectively, the plural payout rates being allocated to plural playing states one by one, and
(e) display, during execution of the basic game, the background color in the one of the plural areas that is allocated to the playing state set in (a) with the different color on the display while displaying the basic game on the display.

10. The gaming machine according to claim 9, wherein
the bet switch and the mode switch include a touch-sensitive sensor for detecting a touching operation on one of the plural areas on the display, and
the controller sets the playing state in (a) according to the one of the plural areas detected through the touch-sensitive sensor.

11. The gaming machine according to claim 10, wherein
the plural areas are segmented by plural concentric circles.

12. The gaming machine according to claim 10, wherein
the plural areas are segmented by nested plural circles that have different diameters, and
each pair of two adjacent circles among the nested plural circles is made eccentric.

13. A control method of a gaming machine including a controller, a selection device, an input device and a display, the method comprising;
(a) with the controller, setting a playing state for the basic game according to a selection operation accepted by the selection device,
(b) with the controller, starting the basic game with the playing state set in (a) when an input is accepted by the input device,
(c) with the controller, displaying plural payout rates for the basic game in plural areas on the display, respectively, the plural areas being allocated to the plural playing states one by one, and
(d) with the controller, setting, during execution of the basic game, a background color in one of the plural areas that is allocated to the playing state set in (a) to a different color from another color of backgrounds in others of the plural areas.
